(19) United States
(12) Patent Application Publication
(10) Pub. No.: US 2026/0050559 A1
(43) Pub. Date: Feb. 19, 2026

(54) COMPUTING SYSTEM CAPABLE OF DETECTING INTERLEAVING CONFIGURATION

(71) Applicant: SK hynix Inc., Icheon-si (KR)

(72) Inventor: Hyung Deok LEE, Icheon-si (KR)

(21) Appl. No.: 19/088,312

(22) Filed: Mar. 24, 2025

(30) Foreign Application Priority Data
Aug. 16, 2024 (KR) 10-2024-0110095

(51) Int. Cl. G06F 13/16; G06F 12/02

(52) U.S. Cl. CPC G06F 13/1642; G06F 12/0246; G06F 13/1673

(57) ABSTRACT

A computing system includes a memory device including a plurality of memory banks, each of the plurality of memory banks storing a plurality of unique identification data, a memory controller configured to control an access operation on the memory device, based on an address mapping order, and a processing unit coupled to the memory device through the memory controller. The processing unit is configured to detect the address mapping order, based on the plurality of unique identification data of the memory device.

### CROSS-REFERENCE TO RELATED APPLICATION

The present application claims priority under 35 U.S.C § 119(a) to Korean Application No. 10-2024-0110095, filed in the Korean Intellectual Property Office on Aug. 16, 2024, the entire contents of which are incorporated herein by reference.

### BACKGROUND

### 1. Technical Field

Various embodiments of the present teachings relate to a computing system and, more particularly, to a computing system capable of detecting an interleaving configuration.

### 2. Related Art

Recently, there has been increasing interest in computing systems that compute machine learning algorithms using acceleration systems and software. In general, the computing system includes a memory device (or a processing-in-memory (PIM) device), a controller, and a processing unit. The memory device (or PIM device) includes a plurality of memory banks, and memory interleaving may be applied for efficient operation of the computing system. The memory interleaving is configured based on an address mapping order defined in the controller. In some computing systems, a single processing unit is combined with various types of memory devices (or PIM devices) and controllers. In this case, a process is required to enable the processing unit to know information about the interleaving configuration, that is, the address mapping order, defined by the memory device (or PIM device) and the controller.

### SUMMARY

A computing system according to an embodiment of the present disclosure may include a plurality of memory banks, each of the plurality of memory banks storing a plurality of unique identification data, a memory controller configured to control an access operation on the memory device, based on an address mapping order, and a processing unit coupled to the memory device through the memory controller. The processing unit may be configured to detect the address mapping order, based on the plurality of unique identification data of the memory device.

A computing system according to an embodiment of the present disclosure may include a memory device including a plurality of memory banks, each of the plurality of memory banks storing a plurality of unique identification data, a memory controller configured to control an access operation on the memory device, based on an address mapping order, a processing unit coupled to the memory device through the memory controller, and a firmware configured to perform a boot process. The firmware may be configured to detect the address mapping order based on the plurality of unique identification data of the memory device and transmit the detected address mapping order to the processing unit while performing the booting process.

A computing system according to an embodiment of the present disclosure may include a processing-in-memory (PIM) device including a plurality of memory banks and a plurality of processing elements, a memory controller configured to control, based on a first address mapping order, a memory access operation for the PIM device and control, based on a second address mapping order, an arithmetic operation of the PIM device, and a processing unit coupled to the PIM device through the memory controller. Each of the plurality of memory banks may include a plurality of unique identification data. The processing unit may be configured to detect the first address mapping order, based on the plurality of unique identification data of the PIM device.

### BRIEF DESCRIPTION OF THE DRAWINGS

FIG. 1 is a block diagram illustrating a computing system according to an embodiment of the present disclosure.

FIG. 2 illustrates an embodiment of a memory device included in a computing system according to an embodiment of the present disclosure.

FIG. 3 illustrates examples of first to fourth portions and fifth to eighth portions of first unique identification data stored in a first memory bank of the memory device of FIG. 2 according to an embodiment of the present disclosure.

FIG. 4 illustrates examples of first to eighth portions of second unique identification data stored in a second memory bank of the memory device of FIG. 2 according to an embodiment of the present disclosure.

FIG. 5 illustrates examples of first to eighth portions of third unique identification data stored in a third memory bank of the memory device of FIG. 2 according to an embodiment of the present disclosure.

FIG. 6 illustrates examples of first to eighth portions of fourth unique identification data stored in a fourth memory bank of the memory device of FIG. 2 according to an embodiment of the present disclosure.

FIG. 7 illustrates an embodiment of a memory controller included in a computing system according to an embodiment of the present disclosure.

FIG. 8 is a flow chart illustrating a process of detecting an address mapping order, based on unique identification data of a memory device in a computing system according to an embodiment of the present disclosure.

FIG. 9 illustrates examples of first to fourth unique identification data stored in a memory device in a computing system according to an embodiment of the present disclosure.

FIG. 10 illustrates an example of unique identification read data stored in a read buffer through a read process for the first to fourth unique identification data of FIG. 9 according to an embodiment of the present disclosure.

FIG. 11 illustrates an example of unique identification read data stored in a read buffer through a read process for the first to fourth unique identification data of FIG. 9 according to an embodiment of the present disclosure.

FIG. 12 illustrates an embodiment of a memory controller included in a computing system according to an embodiment of the present disclosure.

FIG. 13 is a block diagram illustrating a computing system according to an embodiment of the present disclosure.

FIG. 14 is a block diagram illustrating a computing system according to an embodiment of the present disclosure.

FIG. 15 is a diagram illustrating an embodiment of a memory controller included in the computing system of FIG. 14 according to an embodiment of the present disclosure.

FIG. 16 is a diagram illustrating an example of a matrix multiplication operation performed in a PIM device included in the computing system of FIG. 14 according to an embodiment of the present disclosure.

FIG. 17 is a block diagram illustrating a method of storing weight data in memory banks of a PIM device for parallel execution of the matrix multiplication operation of FIG. 16 according to an embodiment of the present disclosure.

FIG. 18 illustrates a first MAC operation process in a state where the method of storing weight data of FIG. 17 is applied according to an embodiment of the present disclosure.

FIG. 19 illustrates a second MAC operation process in a state where the method of storing weight data of FIG. 17 is applied according to an embodiment of the present disclosure.

FIG. 20 illustrates a third MAC operation process in a state where the method of storing weight data of FIG. 17 is applied according to an embodiment of the present disclosure.

FIG. 21 illustrates a fourth MAC operation process in a state where the method of storing weight data of FIG. 17 is applied according to an embodiment of the present disclosure.

FIG. 22 illustrates a process in which first to 64^{th} weight data of a first row of a weight matrix are stored in a PIM device according to a first address mapping order defined in an address mapping table in the computing system of FIG. 14 according to an embodiment of the present disclosure.

FIG. 23 to FIG. 26 illustrate a process in which first to 64^{th} weight data of a first row of a weight matrix and first to 64^{th} weight data of a fourth row are stored in the PIM device according to a second address mapping order in the computing system of FIG. 14 according to an embodiment of the present disclosure.

### DETAILED DESCRIPTION

Terms such as “first” and “second” are used to distinguish between various elements and do not imply size, order, priority, quantity, or importance of the elements. For example, a first element may be referred to as a second element in one example, and the second element may be referred to as a first element in another example.

When an element is referred to as “connected” or “coupled” to another element, the elements may be connected directly or through one or more intervening elements between the elements. When two elements are referred to as “directly connected” or “directly coupled,” one element is directly connected or directly coupled to the other element without an intervening element between the two elements.

Terms such as “over,” “on,” “inside,” “higher,” “high,” “low,” “left,” “right,” “column,” “row,” “level,” and other terms implying relative spatial relationship or orientation are utilized only for the purpose of ease of description or reference to a drawing and are not otherwise limiting.

Embodiments of the present disclosure are described in detail with reference to the accompanying drawings. Specific structural or functional descriptions of embodiments are provided as examples for illustrative purposes to describe concepts that are disclosed in the present application. Examples or embodiments in accordance with the concepts may be carried out in various forms, and the scope of the present disclosure is not limited to the examples or embodiments described in this specification.

It should be understood that the various embodiments described below take DRAM as an example as a memory device, but are not limited thereto. For example, the same may be applied to static random access memory (SRAM), synchronous DRAM (SDRAM), double data rate synchronous DRAM (DDR SDRAM, DDR2 SDRAM, DDR3 SDRAM, etc.), graphics double data rate synchronous DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data output DRAM (EDO DRAM), burst EDO DRAM (BEDO DRAM), multibank DRAM (MDRAM), synchronous graphics RAM (SGRAM), and/or other various forms of DRAM.

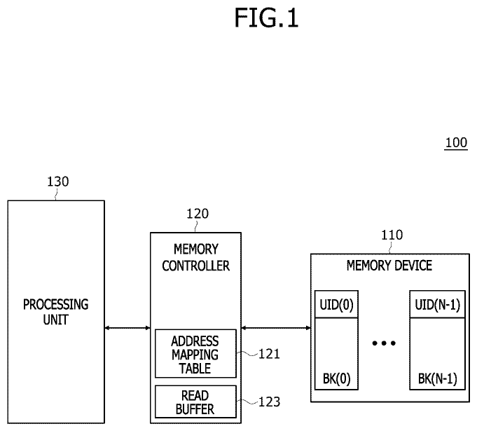

FIG. 1 is a block diagram illustrating a computing system 100 according to an embodiment of the present disclosure.

Referring to FIG. 1, the computing system 100 includes a memory device 110, a memory controller 120, and a processing unit 130. The memory device 110 includes a plurality of memory banks, for example, first to “N” ^{th} (“N” is a natural number) memory banks BK(0)-BK(N−1). Although not shown in FIG. 1, each of the first to “N”^{th} memory banks BK(0)-BK(N−1) may include a memory cell array including a plurality of memory cells. In an embodiment, the memory device 110 may be a volatile memory device, such as a DRAM device. In another embodiment, the memory device 110 may be a nonvolatile memory device, such as a NAND memory device. The first to “N”^{th} memory banks BK(0)-BK(N−1) include data storage regions in which a plurality of unique identification data, for example, first to “N”^{th} unique identification data UID(0)-UID(N−1) are stored. For example, the first memory bank BK(0) includes a first data storage region in which the first unique identification data UID(0) is stored. Similarly, the “N”^{th} memory bank BK(N−1) includes an “N”^{th} data storage region in which the “N”^{th} unique identification data UID(N−1) is stored.

Each of the first to “N”^{th} memory banks BK(0)-BK(N−1) may include a plurality of rows and first to “F”^{th} of column regions. The plurality of rows include a first row group in which a data read operation and a data write operation are performed and a second row group in which the first to “N” ^{th} unique identification data UID(0)-UID(N−1) are stored. Each of the first to “F”^{th} (“F” is a natural number of 2 or more) of column regions may have a size equal to an access granularity of the memory device 110. Among the first to “N”th unique identification data UID(0)-UID(N−1), a “K”th (“K” is a natural number from 1 to “N) unique identification data includes first to “T”th (“T” is (the number of rows belonging to the second row group×“F”)) portions stored in the rows belonging to the second row group of a “K”th memory bank.

The memory controller 120 controls an access operation on the memory device 110. In an embodiment, the access operation includes a read operation for reading data from the memory device 110 and a write operation for writing data to the memory device 110. When the memory device 110 is a DRAM device, the access operation on the memory device 110 may include a refresh operation of the memory device 110. The memory controller 120 includes an address mapping table 121 in which an address mapping order is defined. The memory controller 120 controls, based on the address mapping order defined in the address mapping table 121, the access operation on the memory device 110.

The processing unit 130 is coupled to the memory device 110 through the memory controller 120. In an embodiment, the processing unit 130 is configured to process instructions of an operating system for driving the computing system 100 or instructions of an application program at the request of a user. In an embodiment, the processing unit 130 is a central processing unit (CPU). The processing unit 130 requests data read from the memory device 110 or data write to the memory device 110. The memory controller 120 that receives a data read request from the processing unit 130 reads data, based on the address mapping order defined in the address mapping table 121, from the memory device 110. The memory controller 120 that receives a data write request from the processing unit 130 writes data, based on the address mapping order defined in the address mapping table 121, to the memory device 110.

The processing unit 130 is configured to detect the address mapping order, based on the first to “N”^{th} unique identification data UID(0)-UID(N-1) stored in the first to “N”^{th} memory banks BK(0)-BK(N−1). To this end, the processing unit 130 performs a unique identification data read request operation for the unique identification data to the memory controller 120. The memory controller 120 that is requested to read the unique identification data reads the first to “N”^{th} unique identification data UID(0)-UID(N-1) from the memory device 110 to store the first to “N”^{th} unique identification data UID(0)-UID(N−1) in a read buffer within the memory controller 120. The processing unit 130 analyzes the first to “N”^{th} unique identification data UID(0)-UID(N−1) stored in the read buffer within the memory controller 120 to detect the address mapping order defined in the address mapping table 121 of the memory controller 120.

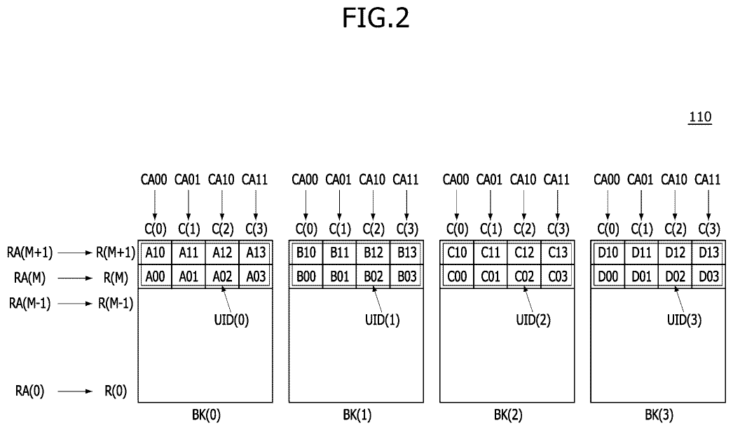

FIG. 2 illustrates an embodiment of a memory device 110 included in a computing system according to an embodiment of the present disclosure.

Referring to FIG. 2, the memory device 110 includes a plurality of memory banks, for example, first to fourth memory banks BK(0)-BK(3). The memory device 110 including four memory banks is only an example, and the memory device 110 may include more than four memory banks. Each of the first to fourth memory banks BK(0)-BK(3) includes a plurality of rows and a plurality of columns. Memory cells are arranged in each of the regions where the plurality of rows and the plurality of columns intersect.

In an embodiment, each of the first to fourth memory banks BK(0)-BK(3) has “M+2” rows, for example, first to “M+2” ^{th} (“M” is a natural number) rows R(0)-R(M+1). Each of the rows of each of the first to fourth memory banks BK(0)-BK(3) may be specified by a row address. For example, the first row R(0) of each of the first to fourth memory banks BK(0)-BK(3) is specified by a first row address RA(0). The “M”^{th} row R(M−1) of each of the first to fourth memory banks BK(0)-BK(3) is specified by an “M”^{th} row address RA(M−1). The “M+1”^{th} row R(M) of each of the first to fourth memory banks BK(0)-BK(3) is specified by an “M+1”^{th} row address RA(M). The “M+2”^{th} row R(M+1) of each of the first to fourth memory banks BK(0)-BK(3) is specified by an “M+2”^{th} row address RA(M+1).

In an embodiment, the plurality of columns included in each of the first to fourth memory banks BK(0)-BK(3) constitute column regions having a size equal to the access granularity of the memory device 110. In an embodiment, the access granularity of the memory device 110 may have a size equal to a size of a cache line within the memory controller 120 of FIG. 1 or the processing unit 130 of FIG. 1. In an embodiment, each of the first to fourth memory banks BK(0)-BK(3) has four column regions, for example, first to fourth column regions C(0)-C(3). However, this is just an example, and each of the first to fourth memory banks BK(0)-BK(3) may have more than four column regions. In an embodiment, when an access granularity for the memory device 110 is 32 bytes, each of the first to fourth column regions C(0)-C(3) has a size of 32 bytes. In this case, each of the first to fourth column regions C(0)-C(3) includes 256 columns for the 32 bytes * 8 bits/byte. The first to fourth column regions C(0)-C(3) may be specified by first to fourth column addresses CA00-CA11, respectively. That is, the first column region C(0) may be specified by the first column address CA00, the second column region C(1) may be specified by the second column address CA01, the third column region C(2) may be specified by the third column address CA10, and the fourth column region C(3) may be specified by the fourth column address CA11.

In an embodiment, the first to “M+2” ^{h} rows R(0)-R(M+1) of each of the first to fourth memory banks BK(0)-BK(3) are divided into a first row group and a second row group. The first row group may be defined as a row region in which data can be stored by the processing unit 130 of FIG. 1 and the memory controller 120 of FIG. 1. Accordingly, general data read operations and data write operations may be performed on the first row group. The second row group may be defined as a row region in which the unique identification data UID(0)-UID(N−1) is stored. For the unique identification data UID(0)-UID(3) stored in the second row group, only a data read operation is performed, and a data write operation is not performed. In an embodiment, the first row group includes the first to “M”^{th} rows R(0)-R(M−1), and the second row group includes the “M+1”^{th} row R(M) and the “M+2” ^{h} row R(M+1). Accordingly, the second row group of the first to fourth memory banks BK(0)-BK(3), that is, the “M+1”^{th} row R(M) and the “M+2”^{th} row R(M+1), maintains a state in which the unique identification data UID(0)-UID(3) is stored.

The first unique identification data UID(0) is stored in the first to fourth column regions C(0)-C(3) of the “M+1”^{th} row R(M) of the first memory bank BK(0) and the first to fourth column regions C(0)-C(3) of the “M+2”^{th} row R(M+1). The first unique identification data UID(0) includes a plurality of portions A00-A03 and A10-A13. The number of the plurality of portions constituting the first unique identification data UID(0) corresponds to “the number of rows belonging to the second row group×the number of column regions belonging to one row”. Accordingly, the first unique identification data UID(0) includes four portions of the first unique identification data UID(0), for example, the first to fourth portions A00-A03 stored in the first to fourth column regions C (0)-C(3) of the “M+1”^{th} row R(M) of the first memory bank BK(0), respectively, and four portions of the first unique identification data UID(0), for example, fifth to eighth portions A10-A13 stored in the first to fourth column regions C(0)-C(3) of the “M+2”^{th} row R(M+1) of the first memory bank BK(0), respectively. The first portion A00 and the fifth portion A10 of the first unique identification data UID(0) are stored in the first column regions C(0) of the “M+1”^{th} row R(M) and the “M+2”^{th} row R(M+1), respectively. The second portion A01 and the sixth portion A11 of the first unique identification data UID(0) are stored in the second column regions C(1) of the “M+1”^{th} row R(M) and the “M+2”^{th} row R(M+1), respectively. The third portion A02 and the seventh portion A12 of the first unique identification data UID(0) are stored in the third column regions C(2) of the“M+1”^{th} row R(M) and the “M+2”^{th} row R(M+1), respectively. In addition, the fourth portion A03 and the eighth portion A13 of the first unique identification data UID(0) are stored in the fourth column regions C(3) of the “M+1”^{th} row R(M) and the “M+2”^{th} row R(M+1), respectively.

Each of the first to eighth portions A00-A03 and A10-A13 of the first unique identification data UID(0), stored in the first memory bank BK(0) includes unique data that specifies the first memory bank BK(0) (hereinafter, referred to as “first bank identification data”). Each of the first to eighth portions A00-A03 and A10-A13 of the first unique identification data UID(0) includes data that specifies a row (hereinafter, referred to as “first row identification data”). In an embodiment, each of the first to fourth portions A00-A03 of the first unique identification data UID(0), stored in the “M+1”^{th} row R(M) has a first binary value, for example, binary value “0” as the first row identification data. On the other hand, each of the fifth to eighth portions A10-A13 of the first unique identification data UID(0), stored in the “M+2”^{th} row R(M+1) has a second binary value, for example, binary value “1”as the first row identification data.

In addition, each of the first to eighth portions A00-A03 and A10-A13 of the first unique identification data UID(0) also includes data that specifies a column region (hereinafter, referred to as “first column identification data”). The first and fifth portions A00 and A10 of the first unique identification data UID(0), stored in the first column region C(0) have first binary values, for example, binary values “00” as the first row identification data. The second and sixth portions A01 and A11 of the first unique identification data UID(0), stored in the second column region C(1) have second binary values, for example, binary values “01” as the first column identification data. The third and seventh portions A02 and A12 of the first unique identification data UID(0), stored in the third column region C(2) have third binary values, for example, binary values “10” as the first column identification data. The fourth and eighth portions A03 and A13 of the first unique identification data UID(0), stored in the fourth column region C(3) have fourth binary values, for example, binary values “11” as the first column identification data.

The second unique identification data UID(1) is stored in the first to fourth column regions C(0)-C(3) of the “M+1”^{th} row R(M) and the first to fourth column regions C(0)-C(3) of the “M+2”^{th} row R(M+1) of the second memory bank BK(1). The second unique identification data UID(1) includes a plurality of portions B00-B03 and B10-B13. The number of the plurality of portions B00-B03 and B10-B13 constituting the second unique identification data UID(1) corresponds to “the number of rows belonging to the second row group×the number of column regions belonging to one row”. Accordingly, the second unique identification data UID(1) includes first to fourth portions B00-B03 of the second unique identification data UID(1), stored in the first to fourth column regions C(0)-C(3) of the “M+1”^{th} row R(M) of the second memory bank BK(1), respectively, and fifth to eighth portions B10-B13 of the second unique identification data UID(1), stored in the first to fourth column regions C(0)-C(3) of the “M+2”^{th} row R(M+1) of the second memory bank BK(1), respectively. The first and fifth portions B00 and B10 of the second unique identification data UID(1) are stored in the first column regions C(0) of the “M+1”^{th} row R(M) and the “M+2”^{th} row R(M+1), respectively. The second and sixth portions B01 and B11 of the second unique identification data UID(1) are stored in the second column regions C(1) of the “M+1”^{th} row R(M) and the “M+2”^{th} row R(M+1), respectively. The third and seventh portions B02 and B12 of the second unique identification data UID(1) are stored in the third column regions C(2) of the “M+1”^{th} row R(M) and the “M+2”^{th} row R(M+1), respectively. In addition, the fourth and eighth portions B03 and B13 of the second unique identification data UID(1) are stored in the fourth column regions C(3) of the “M+1”^{th} row R(M) and the “M+2”^{th} row R(M+1), respectively.

Each of the first to eighth portions B00-B03 and B10-B13 of the second unique identification data UID(1), stored in the second memory bank BK(1) includes unique data that specifies the second memory bank BK(1) (hereinafter, referred to as “second bank identification data”). Each of the first to eighth portions B00-B03l and B10-B13 of the second unique identification data UID(1) includes data that specifies a row (hereinafter, referred to as “second row identification data”). In an embodiment, each of the first to fourth portions B00-B03 of the second unique identification data UID(1), stored in the “M+1”^{th} row R(M) has a first binary value, for example, binary value “0” as the second row identification data. On the other hand, each of the fifth to eighth portions B10-B13 of the second unique identification data UID(1), stored in the “M+2”^{th} row R(M+1) has a second binary value, for example, binary value “1” as the second row identification data.

In addition, each of the first to eighth portions B00-B03 and B10-B13 of the second unique identification data UID(1) also includes data that specifies a column region (hereinafter, referred to as “second column identification data”). The first and fifth portions B00 and B10 of the second unique identification data UID(1), stored in the first column region C(0) have first binary values, for example, binary values “00” as the second row identification data. The second and sixth portions B01 and B11 of the second unique identification data UID(1), stored in the second column region C(1) have second binary values, for example, binary values “01” as the second column identification data. The third and seventh portions B02 and B12 of the second unique identification data UID(1), stored in the third column region C(2) have third binary values, for example, binary values “10”, as the second column identification data. The fourth and eighth portions B03 and B13 of the second unique identification data UID(1), stored in the fourth column region C(3) have fourth binary values, for example, binary values “11”as the second column identification data.

The third unique identification data UID(2) is stored in the first to fourth column regions C(0)-C(3) of the “M+1”^{th} row R(M) and the first to fourth column regions C(0)-C(3) of the “M+2”^{th} row R(M+1) of the third memory bank BK(2). The third unique identification data UID(2) includes a plurality of portions C00-C03 and C10-C13. The number of the plurality of portions C00-C03 and C10-C13 constituting the third unique identification data UID(2) corresponds to “the number of rows belonging to the second row group×the number of column regions belonging to one row”. Accordingly, the third unique identification data UID(2) includes first to fourth portions C00-C03 of the third unique identification data UID(2), stored in the first to fourth column regions C(0)-C(3) of the “M+1”^{th} row R(M) of the third memory bank BK(2), respectively, and the fifth to eighth portions C10-C13 of the third unique identification data UID(2), stored in the first to fourth column regions C(0)-C(3) of the “M+2”^{th} row R(M+1) of the third memory bank BK(2), respectively. The first and fifth portions C00 and C10 of the third unique identification data UID(2) are stored in the first column regions C(0) of the “M+1”^{th} row R(M) and the “M+2”^{th} row R(M+1), respectively. The second and sixth portions C01 and C11 of the third unique identification data UID(2) are stored in the second column regions C(1) of the “M+1”^{th} row R(M) and the “M+2”^{th} row R(M+1), respectively. The third and seventh portions C02 and C12 of the third unique identification data UID(2) are stored in the third column regions C(2) of the “M+1”^{th} row R(M) and the “M+2”^{th} row R(M+1), respectively. In addition, the fourth and eighth portions C03 and C13 of the third unique identification data UID(2) are stored in the fourth column regions C(3) of the “M+1”^{th} row R(M) and the “M+2”^{th} row R(M+1), respectively.

Each of the first to eighth portions C00-C03 and C10-C13 of the third unique identification data UID(2), stored in the third memory bank BK(2) includes unique data that specifies the third memory bank BK(2) (hereinafter, referred to as “third bank identification data”). Each of the first to eighth portions C00-C03 and C10-C13 of the third unique identification data UID(2) includes data that specifies a row (hereinafter, referred to as “third row identification data”). In an embodiment, each of the first to fourth portions C00-C03 of the third unique identification data UID(2), stored in the “M+1”^{th} row R(M) has a first binary value, for example, binary value “0” as the third row identification data. On the other hand, each of the fifth to eighth portions C10-C13 of the third unique identification data UID(2), stored in the “M+2”^{th} row R(M+1) has a second binary value, for example, binary value “1”as the third row identification data.

In addition, each of the first to eighth portions C00-C03 and C10-C13 of the third unique identification data UID(2) also includes data that specifies a column region (hereinafter, referred to as “third column identification data”). The first and fifth portions C00 and C10 of the third unique identification data UID(2), stored in the first column region C(0) have first binary values, for example, binary values “00” as the third row identification data. The second and sixth portions C01 and C11 of the third unique identification data UID(2), stored in the second column region C(1) have second binary values, for example, binary values “01” as the third column identification data. The third and seventh portions C02 and C12 of the third unique identification data UID(2), stored in the third column region C(2) have third binary values, for example, binary values “10” as the third column identification data. The fourth and eighth portions C03 and C13 of the third unique identification data UID(2), stored in the fourth column region C(3) have fourth binary values, for example, binary values “11” as the third column identification data.

The fourth unique identification data UID(3) is stored in the first to fourth column regions C(0)-C(3) of the “M+1”^{th} row R(M) and the first to fourth column regions C(0)-C(3) of the “M+2”^{th} row R(M+1) of the fourth memory bank BK(3). The fourth unique identification data UID(3) includes a plurality of portions D00-D03 and D10-D13. The number of the plurality of portions D00-D03 and D10-D13 constituting the fourth unique identification data UID(3) corresponds to “the number of rows belonging to the second row group ×the number of column regions belonging to one row”. Accordingly, the fourth unique identification data UID(3) includes first to fourth portions D00-D03 of the fourth unique identification data UID(2), stored in the first to fourth column regions C(0)-C(3) of the “M+1”^{th} row R(M) of the fourth memory bank BK(3), respectively, and the fifth to eighth portions D10-D13 of the fourth unique identification data UID(3), stored in the first to fourth column regions C(0)-C(3) of the “M+2”^{th} row R(M+1) of the fourth memory bank BK(3), respectively. The first and fifth portions D00 and D10 of the fourth unique identification data UID(3) are stored in the first column region C(0) of the “M+1”^{th} row R(M) and the “M+2”^{th} row R(M+1), respectively. The second and sixth portions D01 and D11 of the fourth unique identification data UID(3) are stored in the second column region C(1) of the “M+1”^{th} row R(M) and the “M+2”^{th} row R(M+1), respectively. The third and seventh portions D02 and D12 of the fourth unique identification data UID(3) are stored in the third column region C(2) of the “M+1”^{th} row R(M) and the “M+2”^{th} row R(M+1), respectively. In addition, the fourth and eighth portions D03 and D13 of the fourth unique identification data UID(3) are stored in the fourth column region C(3) of the “M+1”^{th} row R(M) and the “M+2”^{th} row R(M+1), respectively.

Each of the first to eighth portions D00-D03 and D10-D13 of the fourth unique identification data UID(3), stored in the fourth memory bank BK(3) includes unique data that specifies the fourth memory bank BK(3) (hereinafter, referred to as “fourth bank identification data”). Each of the first to eighth portions D00-D03 and D10-D13 of the fourth unique identification data UID(3) includes data that specifies a row (hereinafter, referred to as “fourth row identification data”). In an embodiment, each of the first to fourth portions D00-D03 of the fourth unique identification data UID(3) stored in the “M+1”^{th} row R(M) has a first binary value, for example, binary value “0” as the fourth row identification data. On the other hand, each of the fifth to eighth portions D10-D13 of the fourth unique identification data UID(3), stored in the “M+2”^{th} row R(M+1) has a second binary value, for example, binary value “1” as the fourth row identification data.

In addition, each of the first to eighth portions D00-D03 and D10-D13 of the fourth unique identification data UID(3) also has data that specifies a column region (hereinafter, referred to as “fourth column identification data”). The first and fifth portions D00 and D10 of the fourth unique identification data UID(3), stored in the first column region C(0) has first binary values, for example, binary values “00” as the fourth row identification data. The second and sixth portions D01 and D11 of the fourth unique identification data UID(3), stored in the second column region C(1) have second binary values, for example, binary values “01” as the fourth column identification data. The third and seventh portions D02 and D12 of the fourth unique identification data UID(3), stored in the third column region C(2) have third binary values, for example, binary values “10” as the fourth column identification data. The fourth and eighth portions D03 and D13 of the fourth unique identification data UID(3), stored in the fourth column region C(3) have fourth binary values, for example, binary values “11”as the fourth column identification data.

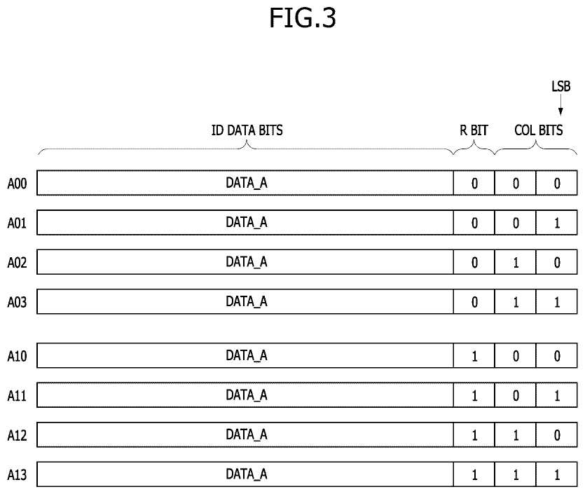

FIG. 3 illustrates an example of first to eighth portions of first unique identification data stored in the first memory bank of the memory device of FIG. 2.

Referring to FIG. 3 together with FIG. 2, each of the first to eighth portions A00-A03 and A10-A13 of the first unique identification data UID(0) includes column identification bits COL BITS, a row identification bit R BIT, and identification data bits ID DATA BITS. As described with reference FIG. 2, as each of the rows of the first memory bank BK(0) includes four column regions C(0)-C(3), each of the column identification bits COL BITS has a value of “n” that satisfies a condition of “2n≥4” (where “4” represents the number of column regions), that is, a size of 2-bit. As the first unique identification data UID(0) in the first memory bank BK(0) is stored in two rows, that is, the “M+1”^{th} row R(M) and the “M+2”^{th} row R(M+1), the row identification bit R BIT has a value of “m” that satisfies a condition of “2m≥2”, that is, a size of 1-bit. Because each of the first to eighth portions A00-A03 and A10-A13 of the first unique identification data UID(0) has a size of an access granularity, the identification data bits ID DATA BITS have a bit size obtained by subtracting the number of bits of column identification bits COL BITS and the number of bits of row identification bits R BIT from the access granularity.

The column identification bits COL BITS of each of the first to eighth portions A00-A3 and A10-A13 constituting the first unique identification data UID(0) have binary values corresponding to the first column identification data. As illustrated in FIG. 2 and FIG. 3, the first and fifth portions A00 and A10 of the first unique identification data UID(0), stored in the first column region C(0) of the first memory bank BK(0) have binary values of “00” stored in the column bits COL BITS as the first column identification data. The second and sixth portions A01 and A11 of the first unique identification data UID(0), stored in the second column region C(1) of the first memory bank BK(0) have binary values of “01” stored in the column bits COL BITS as the first column identification data. The third and seventh portions A02 and A12 of the first unique identification data UID(0), stored in the third column region C(2) of the first memory bank BK(0) have binary values of “10” stored in the column bits COL BITS as the first column identification data. In addition, the fourth and eighth portions A03 and A13 of the first unique identification data UID(0), stored in the fourth column region C(3) of the first memory bank BK(0) have binary values of “11” stored in the column bits COL BITS as the first column identification data.

The row identification bit R BIT of each of the first to eighth portions A00-A03 and A10-A13 constituting the first unique identification data UID(0) has a binary value corresponding to first row identification data. As illustrated in FIGS. 2 and 3, each of the first to fourth portions A00-A03 of the first unique identification data UID(0), stored in the “M+1”^{th} row R(M) of the first memory bank BK(0) has a binary value of “0” stored in the row bit R BIT as the first row identification data. Each of the fifth to eighth portions A10-A13 of the first unique identification data UID(0), stored in the “M+2”^{th} row R(M+1) of the first memory bank BK(0) has a binary value of “1” stored in the row bit R BIT as the first row identification data.

In the identification data bits ID DATA BITS of the first to eighth portions A00-A03 and A10-A13 constituting the first unique identification data UID(0), binary values that specify the first memory bank BK(0) are stored as first bank identification data DATA_A. Because the first to eighth portions A00-A03 and A10-A13 constituting the first unique identification data UID(0) are all stored in the first memory bank BK(0), the first bank identification data DATA_A stored in the identification data bits ID DATA BITS of the first to eighth portions A00-A03 and A10-A13 constituting the first unique identification data UID(0) may all include the same binary values.

In this way, through the binary values of the first bank identification data DATA_A stored in the identification data bits ID DATA BITS of the first to eighth portions A00-A03 and A10-A13 constituting the first unique identification data UID(0), it is possible to determine whether the memory bank in which the first to eighth portions A00-A03 and A10-A13 constituting the first unique identification data UID(0) are stored is the first memory bank BK(0). In addition, through the binary values of the first column identification data and the binary values of the first row identification data, respectively stored in the column bits COL BITS and the row bits R BIT of the first to eighth portions A00-A03 and A10-A13 constituting the first unique identification data UID(0), it is possible to determine which row and which column region each of the first to eighth portions A00-A03 and A10-A13 constituting the first unique identification data UID(0) is stored in.

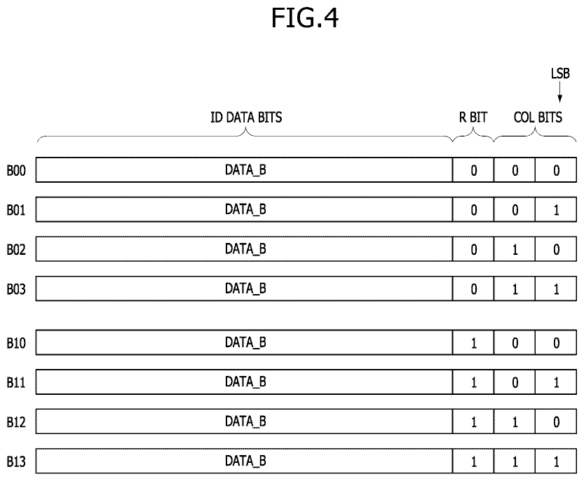

FIG. 4 illustrates an example of first to eighth portions of second unique identification data stored in the second memory bank of the memory device of FIG. 2.

Referring to FIG. 4 together with FIG. 2, each of the first to eighth portions B00-B03 and B10-B13 constituting the second unique identification data UID(1) includes column identification bits COL BITS, a row identification bit R BIT, and identification data bits ID DATA BITS. The composition of the column identification bits COL BITS and the row identification bit R BIT included in the first to eighth portions B00-B03 and B10-B13 constituting the second unique identification data UID(1) may be substantially the same as the composition of the column identification bits COL BITS and the row identification bit R BIT included in the first to eighth portions A00-A03 and A10-A13 constituting the first unique identification data UID(1) described with reference to FIG. 3. Accordingly, the column identification bits COL BITS of each of the first to eighth portions B00-B03 and B10-B13 constituting the second unique identification data UID(1) have binary values corresponding to second column identification data. In addition, the row identification bit R BIT of each of the first to eighth portions B00-B03 and B10-B13 constituting the second unique identification data UID(1) has a binary value corresponding to second row identification data.

In the identification data bits ID DATA BITS of the first to eighth portions B00-B03 and B10-B13 constituting the second unique identification data UID(1), binary values that specify the second memory bank BK(1) are stored as second bank identification data DATA_B. Because the first to eighth portions B00-B03 and B10-B13 constituting the second unique identification data UID(1) are all stored in the second memory bank BK(1), the second bank identification data DATA_B stored in the identification data bits ID DATA BITS of the first to eighth portions B00-B03 and B10-B13 constituting the second unique identification data UID(1) may all include the same binary values.

In this way, through the binary values of the second bank identification data DATA_B stored in the identification data bits ID DATA BITS of the first to eighth portions B00-B03 and B10-B13 constituting the second unique identification data UID(1), it is possible to determine whether the memory bank in which the first to eighth portions B00-B03 and B10-B13 constituting the second unique identification data UID(1) are stored is the second memory bank BK(1). In addition, through the binary values of the second column identification data and the binary values of the second row identification data, respectively stored in the column bits COL BITS and the row bits R BIT of each of the first to eighth portions B00-B03 and B10-B13 constituting the second unique identification data UID(1), it is possible to determine which row and which column region each of the first to eighth portions B00-B03 and B10-B13 constituting the second unique identification data UID(1) are stored in.

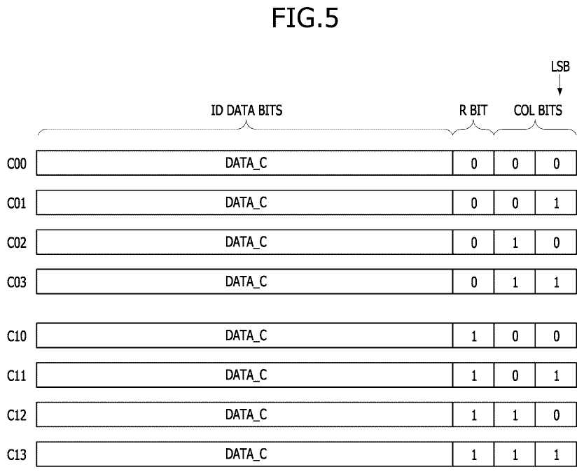

FIG. 5 illustrates an example of first to eighth portions of third unique identification data stored in the third memory bank of the memory device of FIG. 2.

Referring to FIG. 5 together with FIG. 2, each of the first to eighth portions C00-C03 and C10-C13 of the third unique identification data UID(2) includes column identification bits COL BITS, a row identification bit R BIT, and identification data bits ID DATA BITS. The composition of the column identification bits COL BITS and the row identification bit R BIT included in each of the first to eighth portions C00-C03 and C10-C13 constituting the third unique identification data UID(2) may be substantially the same as the composition of the column identification bits COL BITS and the row identification bit R BIT of each of the first to eighth portions A00-A03 and A10-A13 constituting the first unique identification data UID(0) described with reference FIG. 3. Accordingly, the column identification bits COL BITS of each of the first to eighth portions C00-C03 and C10-C13 constituting the third unique identification data UID(2) have binary values corresponding to third column identification data. In addition, the row identification bit R BIT of each of the first to eighth portions C00-C03 and C10-C13 constituting the third unique identification data UID(2) has a binary value corresponding to third row identification data.

In the identification data bits ID DATA BITS of the first to eighth portions C00-C03 and C10-C13 constituting the third unique identification data UID(2), binary values that specify the third memory bank BK(2) are stored as third bank identification data DATA_C. Because the first to eighth portions C00-C03 and C10-C13 constituting the third unique identification data UID(2) are all stored in the third memory bank BK(2), the third bank identification data DATA_C stored in the identification data bits ID DATA BITS of the first to eighth portions C00-C03 and C10-C13 constituting the third unique identification data UID(2) may all include the same binary values.

In this way, through the binary values of the third bank identification data DATA_C stored in the identification data bits ID DATA BITS of the first to eighth portions C00-C03 and C10-C13 constituting the third unique identification data UID(2), it is possible to determine whether the memory bank in which the first to eighth portions C00-C03 and C10-C13 constituting the third unique identification data UID(2) are stored is the third memory bank BK(2). In addition, through the binary values of the third column identification data and the binary values of the third row identification data stored in the column bits COL BITS and the row bits R BIT of the first to eighth portions C00-C03 and C10-C13 constituting the third unique identification data UID(2), it is possible to determine which row and which column region each of the first to eighth portions C00-C03 and C10-C13 constituting the third unique identification data UID(2) are stored in.

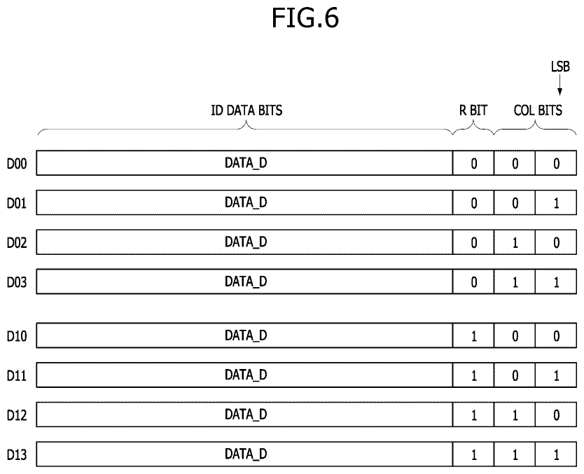

FIG. 6 illustrates an example of first to eighth portions of fourth unique identification data stored in the fourth memory bank of the memory device of FIG. 2.

Referring to FIG. 6 together with FIG. 2, each of the first to eighth portions D00-D03 and D10-D13 constituting the fourth unique identification data UID(3) includes column identification bits COL BITS, a row identification bit R BIT, and identification data bits ID DATA BITS. The compositions of the column identification bits COL BITS and the row identification bit R BIT included in each of the first to eighth portions D00-D03 and D10-D13 constituting the fourth unique identification data UID(3) may be substantially the same as the composition of the column identification bits COL BITS and row identification bits R BIT included in each of the first to eighth portions A00-A03 and A10-A13 constituting the first unique identification data UID(0) described with reference to FIG. 3. Accordingly, the column identification bits COL BITS of each of the first to eighth portions D00-D03 and D10-D13 constituting the fourth unique identification data UID(3) have binary values corresponding to fourth column identification data. In addition, the row identification bits R BIT of each of the first to eighth portions D00-D03 and D10-D13 constituting the fourth unique identification data UID(3) has a binary value corresponding to fourth row identification data.

In the identification data bits ID DATA BITS of the first to eighth portions D00-D03 and D10-D13 constituting the fourth unique identification data UID(3), binary values that specify the fourth memory bank BK(3) are stored as fourth bank identification data DATA_D. Because the first to eighth portions D00-D03 and D10-D13 constituting the fourth unique identification data UID(3) are stored in the fourth memory bank BK(3), the fourth bank identification data DATA_D stored in the identification data bits ID DATA BITS of the first to eighth portions D00-D03 and D10-D13 constituting the fourth unique identification data UID(3) may include the same binary values.

In this way, through the binary values of the fourth bank identification data DATA_D stored in the identification data bits ID DATA BITS of the first to eighth portions D00-D03 and D10-D13 constituting the fourth unique identification data UID(3), it is possible to determine whether the memory bank in which the first to eighth portions D00-D03 and D10-D13 constituting the fourth unique identification data UID(3) are stored is the fourth memory bank BK(3). In addition, through the binary values of the fourth column identification data and the binary value of the fourth row identification data, respectively stored in the column bits COL BITS and the row bits R BIT of the first to eighth portions D00-D03 and D10-D13 constituting the fourth unique identification data UID(3), it is possible to determine which row and which column region each of the first to eighth portions D00-D03 and D10-D13 constituting the fourth unique identification data UID(3) are stored in.

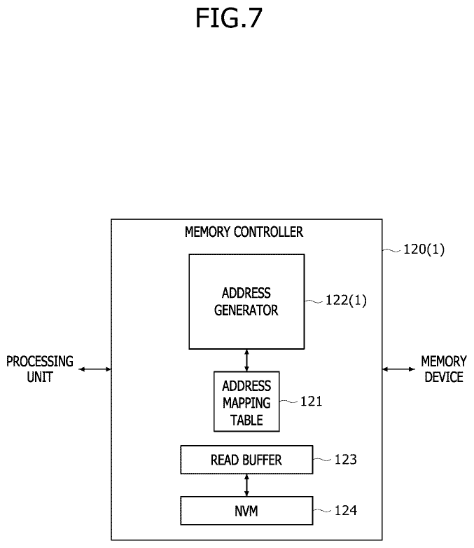

FIG. 7 illustrates an embodiment of a memory controller 120(1) included in a computing system according to the present disclosure.

Referring to FIG. 7, the memory controller 120(1) includes an address mapping table 121, an address generator 122(1), a read buffer 123, and a nonvolatile memory (NVM) 124. Although not shown in FIG. 7, the memory controller 120(1) may include various components for accessing a memory device, such as a command generator and a write buffer. As described with reference to FIG. 1, an address mapping order is defined in the address mapping table 121. In an example, the address mapping order represents a decoding order between banks, rows, and columns. In another example, the address mapping order represents a decoding order between channels, banks, rows, and columns. In another example, the address mapping order represents a decoding order between ranks, channels, banks, rows, and columns.

The address generator 122(1) generates a physical address corresponding to the address mapping order for a virtual address transmitted from a processing unit to transmit the physical address to a memory device. The read buffer 123 has a plurality of storage regions in which read data read out from the memory device is stored. The read data stored in the read buffer 123 may be transmitted to the processing unit. Some physically continuous storage regions among the plurality of storage regions of the read buffer 123 may be separately allocated to store unique identification data read from the memory device (hereinafter, referred to as “unique identification read data”). The nonvolatile memory (NVM) 124 receives the unique identification read data stored in the read buffer 123 from the read buffer 123 and stores the unique identification read data. Accordingly, the processing unit may detect, based on the unique identification read data stored in the nonvolatile memory 124, the address mapping order, regardless of whether the unique identification read data is stored in the read buffer 123.

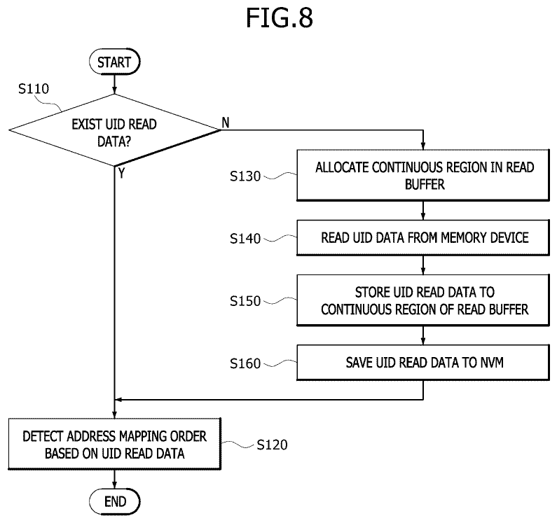

FIG. 8 is a flow chart illustrating a process of detecting an address mapping order in a computing system according to the present disclosure.

Referring to FIG. 8, together with FIG. 1 and FIG. 7, in operation S110, a processing unit 130 determine whether unique identification read data exists in a read buffer 123 or a nonvolatile memory 124 of a memory controller 120. When the unique identification read data exists in the read buffer 123 or the nonvolatile memory 124 of the memory controller 120, in operation S120, the processing unit 130 detects the address mapping order, based on the unique identification read data stored in the read buffer 123 or the nonvolatile memory 124. The process of detecting, based on the unique identification read data, the address mapping order is described in more detail below.

When the unique identification read data does not exist in the read buffer 123 or nonvolatile memory 124 of the memory controller 120, in operation S130, the processing unit 130 allocates physically continuous storage regions in the read buffer 123 of the memory controller 120 as storage regions for storing the unique identification data. In operation S140, the memory controller 120 reads the unique identification data from a memory device 110. To this end, the processing unit 130 transmits a read request for the unique identification data to the memory controller 120. In operation S150, the memory controller 120 stores the unique identification data that is read from the memory device 110 as the unique identification read data in the allocated storage regions of the read buffer 123. In operation S160, the memory controller 120 saves the unique identification read data stored in the read buffer 123 in the nonvolatile memory 124. In operation S120, the address mapping order is detected based on the unique identification read data stored in the nonvolatile memory 124. In other embodiments, the operation S160 may be skipped.

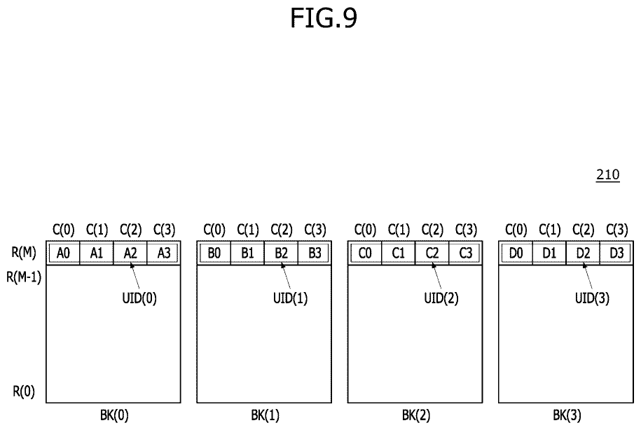

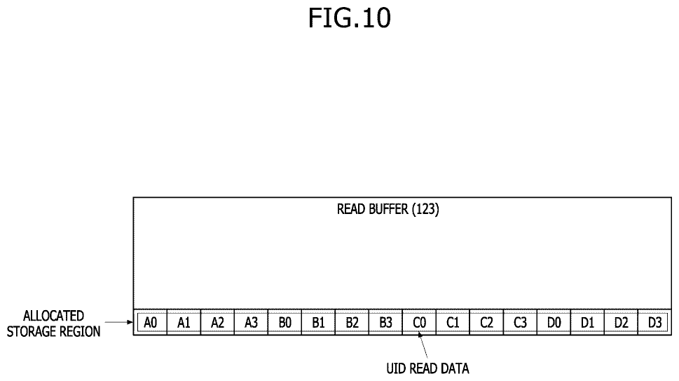

FIG. 9 illustrates an example of first to fourth unique identification data stored in a memory device 210 in a computing system according to the present disclosure. FIG. 10 illustrates an example of unique identification read data stored in a read buffer through a read process for the first to fourth unique identification data of FIG. 9.

First, as shown in FIG. 9, it is assumed that the memory device 210 includes first to fourth memory banks BK(0)-BK(3) and the first to fourth unique identification data UID(0)-UID(3) are stored in an “M+1”^{th} row R(M) of each of the first to fourth memory banks BK(0)-BK(3), respectively. In addition, it is assumed that each of the first to fourth memory banks BK(0)-BK(3) includes first to fourth column regions C(0)-C(3). Accordingly, first to fourth portions A0-A3 of the first unique identification data UID(0) are stored in the first to fourth column regions C(0)-C(3) of the “M+1”^{th} row R(M) of the first memory bank BK(0), respectively. In the first to fourth column regions C(0)-C(3) of the “M+1”^{th} row R(M) of the second memory bank BK(1), first to fourth portions B0-B3 of the second unique identification data UID(1) are stored, respectively. In the first to fourth column regions C(0)-C(3) of the “M+1”^{th} row R(M) of the third memory bank BK(2), first to fourth portions C0-C3 of the third unique identification data UID(2) are stored, respectively. In addition, in the first to fourth column regions C(0)-C(3) of the “M+1”^{th} row R(M) of the fourth memory bank BK(3), first to fourth portions D0-D3 of the fourth unique identification data UID(3) are stored, respectively.

The processing unit 130 transmits a read request for the first to fourth unique identification data UID(3) to the memory controller 120. When there is the unique identification read data in the read buffer 123, the memory controller 120 transmits the unique identification read data stored in the read buffer 123 to the processing unit 130. When there is no unique identification read data within the read buffer 123, the memory controller 120 allocates physically continuous storage regions within the read buffer 123. The memory controller 120 reads the first to fourth unique identification data UID(0)-UID(3) from the memory device 210 and stores the first to fourth unique identification data UID(0)-UID(3) as the unique identification read data in the allocated storage regions of the read buffer 123. The memory controller 120 transmits the unique identification read data stored in the read buffer 123 to the processing unit 130.

As shown in FIG. 10, a case where the unique identification read data stored in the allocated storage region of the read buffer 123 is transmitted from the memory device 210 in the order of “A0, A1, A2, A3, B0, B1, B2, B3, C0, C1, C2, C3, D0, D1, D2, D3” is taken as an example. In this case, the first unique identification data UID(0), the second unique identification data UID(1), the third unique identification data UID(2), and the fourth unique identification data UID(3) are read from the memory device 210 to the read buffer 123 in that order. That is, a read operation is first performed on the first to fourth column regions C(0)-C(3) of the “M+1”^{th} row R(M) of the first memory bank BK(0). Next, a read operation is performed on the first to fourth column regions C(0)-C(3) of the “M+1”^{th} row R(M) of the second memory bank BK(1). Next, a read operation is performed on the first to fourth column regions C(0)-C(3) of the “M+1”^{th} row R(M) of the third memory bank BK(2). Finally, a read operation is performed on the first to fourth column regions C(0)-C(3) of the “M+1”^{th} row R(M) of the fourth memory bank BK(3). That is, among the columns, banks, and rows which constitute the address mapping, the read operation is performed in the following order: column increases first, followed by bank increases. Accordingly, the processing unit 130 may detect that the address mapping is defined in the order of row-bank-column.

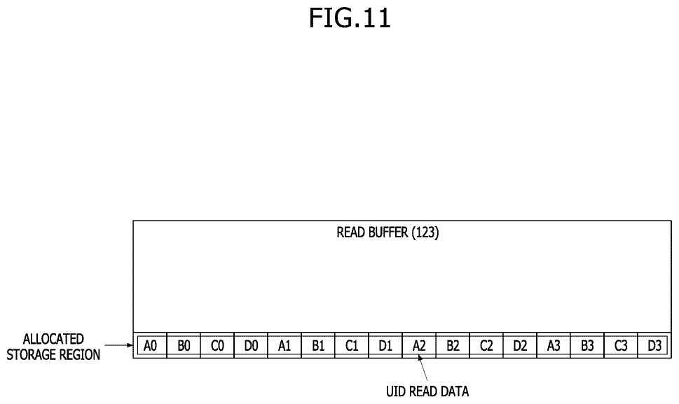

FIG. 11 illustrates an example of unique identification read data stored in a read buffer through a read process for the first to fourth unique identification data of FIG. 9.

As shown in FIG. 11, a case where unique identification read data stored in an allocated storage region of a read buffer 123 is transmitted from a memory device 210 in the order of “A0, B0, C0, D0, A1, B1, C1, D1, A2, B2, C2, D2, A3, B3, C3, D3” is taken as an example. In this case, the first portions A0, B0, C0, D0, the second portions A1, B1, C1, D1, the third portions A2, B2, C2, D2, and the fourth portions A3, B3, C3, D3 of the first unique identification data UID(0), the second unique identification data UID(1), the third unique identification data UID(2), and the third unique identification data UID(3) are read from the memory device 210 to the read buffer 123 in that order. That is, first, a read operation is sequentially performed on the first column region C(0) of the “M+1”^{th} row R(M) of each of the first to fourth memory banks BK(0)-BK(3). Next, a read operation is sequentially performed on the second column region C(1) of the “M+1”^{th} row R(M) of each of the first to fourth memory banks BK(0)-BK(3). Next, a read operation is sequentially performed on the third column region C(2) of the “M+1”^{th} row R(M) of each of the first to fourth memory banks BK(0)-BK(3). Finally, a read operation is sequentially performed on the fourth column region C(3) of the “M+1”^{th} row R(M) of each of the first to fourth memory banks BK(0)-BK(3). That is, among the columns, banks, and rows which constitute the address mapping, the read operation is performed in the following order: bank increases first, followed by column increases. Accordingly, the processing unit 130 may detect that the address mapping is defined in the order of row-column-bank.

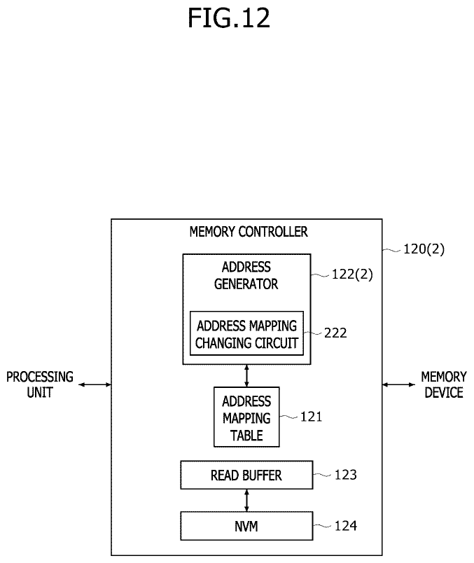

FIG. 12 illustrates an embodiment of a memory controller 120(2) included in a computing system according to the present disclosure. In FIG. 12, the same reference numerals as in FIG. 7 represent the same components, and duplicate description is omitted below.

Referring to FIG. 12, the memory controller 120(2) includes an address mapping table 121, an address generator 122(2), a read buffer 123, and a nonvolatile memory (NVM) 124. The address generator 122(2) includes an address mapping changing circuit 222. The address mapping changing circuit 222 is configured to change the address mapping order defined in the address mapping table 121. For example, when the address mapping order is defined in the order of row-bank-column in the address mapping table 121, the address mapping changing circuit 222 changes the address mapping order into the order of row-column-bank. In an example, the processing unit detects the address mapping order defined in the address mapping table 121 through a read operation on unique identification data included in the memory device. The processing unit may request the memory controller 120(2) to generate addresses in an address mapping order different from the detected address mapping order for efficient operation of the memory system. The address generator 122(2) of the memory controller 120(2) generates an address remapped in the requested address mapping order through the address mapping changing circuit 222 in response to the request from the processing unit and transmit the remapped address to the memory device.

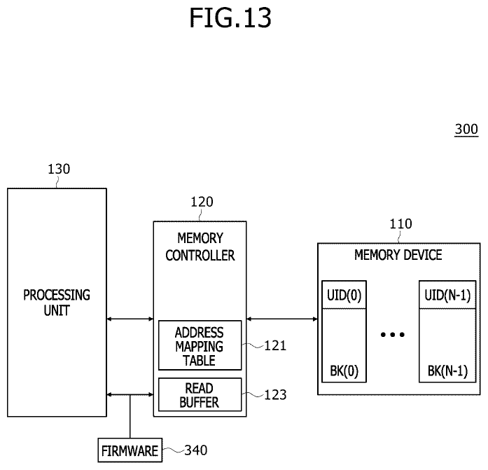

FIG. 13 is a block diagram illustrating a computing system 300 according to an embodiment of the present disclosure. In FIG. 13, the same reference numerals as in FIG. 1 represent the same components, and duplicate description is omitted below.

Referring to FIG. 13, the computing system 300 includes a memory device 110, a memory controller 120, a processing unit 130, and a firmware 340. The memory device 110 includes first to “N”^{th} unique identification data UID(0)-UID(N−1) stored in first to “N”^{th} memory banks BK(0)-BK(N−1), respectively, as described with reference to FIG. 1 to FIG. 6. A configuration of the memory controller 120 may be the same as the configuration of the memory controller 120(1) described with reference to FIG. 7 or the configuration of the memory controller 120(2) described with reference to FIG. 12.

The firmware 340 may be configured in a form of a ROM in which commands and data for executing basic operation and control of the computing system 300 are stored. The firmware 340 is coupled to the memory controller 120 and the processing unit 130. The firmware 340 is configured to allow a booting process of the computing system 300 to be performed. For example, the firmware 140 allows hardware diagnosis, date and time setting, boot mode setting, boot order setting, etc. to be performed through the boot process. When the memory device 110 has serial presence detect (SPD) information (or SPD data), the firmware 340 may calculate a burst length of the memory device 110, the number of bits of the column address, the number of bits of the row address, the number of bits of the bank address, the number of channels, etc. through the SPD information of the memory device 110 during the booting process. In this case, the firmware 340 calculates the row size using the SPD information read from the memory device 110. The row size may be calculated by the formula “access granularity×2^{number of column bits}”. For example, when the access granularity is 1 byte and the number of bits in the column address is “2”, the row size is calculated as 1-byte ×2²=4 bytes. When the memory device 110 does not have the SPD information, the firmware 340 may have data regarding the burst length of the memory device 110, the number of bits in the column address, the number of bits in the row address, the number of bits in the bank address, the number of channels, etc.

The firmware 340 calculates the number of portions of the unique identification data to be read, corresponding to the calculated row size. In an example, the number of portions of the unique identification data to be read may be calculated by the formula “burst length×2^{(number of bits of column address)}×2^{(number of bits of bank address)}.” For example, when information is obtained through the SPD information that the burst length is “1”, the number of bits of column address is “2”, and the number of bits of bank address is “2,” a read operation may be performed on 16 portions of the unique identification data to be read, which is 2×1²×2²=16 portions of the unique identification data. In an example, as described with reference to FIG. 2, when the portions of the unique identification data are stored in two or more rows, the portions of the unique identification data up to twice the calculated number may be read to read the portions of the unique identification data stored in all column regions. That is, when the number of portions of the unique identification data to be read through the SPD information is calculated as “16,” a read operation is performed for up to “32” portions of the unique identification data. In this case, even though one of the first to fourth column regions C(0)-C(3) is read, the portions of the unique identification data stored in all column regions can be read.

Once the number of portions of the unique identification data to be read is calculated, the firmware 340 performs a read operation on the unique identification data of the memory device 110. Specifically, the firmware 340 allocates physically continuous storage regions in the read buffer 123 of the memory controller 120 as storage regions to store the unique identification data. The firmware 340 reads the unique identification data from the memory device 110 and stores the read unique identification data as the unique identification read data in the allocated storage regions of the read buffer 123. The firmware 340 stores the unique identification data stored in the read buffer 123 in the nonvolatile memory 124. In addition, the firmware 340 detects an address mapping order, based on the unique identification read data stored in the nonvolatile memory 124. The firmware 340 provides the detected address mapping order to the processing unit 130.

In an example, when the configurations of the memory device 110 and the memory controller 120 in the computing system 300 are changed, the firmware 340 performs a read process for the unique identification data. In the computing system 300, when the configurations of the memory device 110 and the memory controller 120 are not changed, that is, when a read process for the unique identification data has been performed previously and the unique identification read data is stored in the memory controller 120, the firmware 340 detects the memory mapping order through the unique identification read data stored in the memory controller 120 without performing the read process for the unique identification data during the boot process.

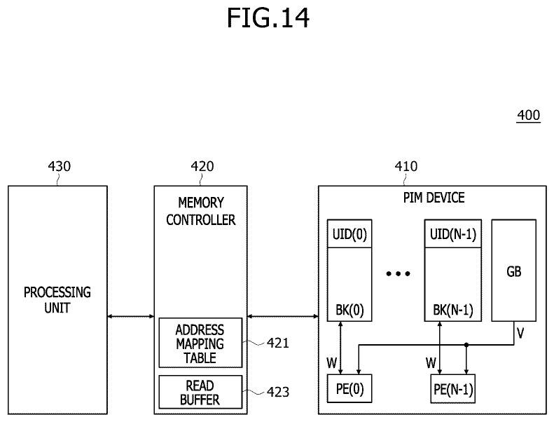

FIG. 14 is a block diagram illustrating a computing system 400 according to an embodiment of the present disclosure. Referring to FIG. 14, the computing system 400 includes a processing-in-memory (PIM) device 410, a memory controller 420, and a processing unit 430.

The PIM device 410 includes a plurality of memory banks, for example, first to “N”^{th} memory banks BK(0)-BK(N−1) (“N” is a natural number), a global buffer GB, and a plurality of processing elements, for example, first to “N”^{th} processing elements PE(0)-PE(N−1). The first to “N”^{th} processing elements PE(0)-PE(N−1) are coupled to the first to “N”^{th} memory banks BK(0)-BK(N−1), respectively. The first to “N”^{th} processing elements PE(0)-PE(N−1) are coupled to the global buffer GB in common.

Each of the first to “N”^{th} memory banks BK(0)-BK(N−1) includes a memory cell array including a plurality of memory cells. The first to “N”^{th} memory banks BK(0)-BK(N−1) include data storage regions in which a plurality of unique identification data, for example, first to “N”^{th} unique identification data UID(0)-UID(N−1) are stored. For example, the first memory bank BK(0) includes a first data storage region in which the first unique identification data UID(0) is stored. Similarly, the “N”^{th} memory bank BK(N−1) includes an “N”^{th} data storage region in which the “N”^{th} unique identification data UID(N−1) is stored. The method of storing the unique identification data described with reference to FIG. 2 to FIG. 6 may be equally applied to a method of storing the unique identification data in the first to “N”^{th} memory banks BK(0)-BK(N−1) of the PIM device 410.

The first to “N”^{th} processing elements PE(0)-PE(N−1) receive data from the first to “N”^{th} memory banks BK(0)-BK(N−1), respectively, and perform an arithmetic operation using the received data. In an embodiment, each of the first to “N”^{th} processing elements PE(0)-PE(N−1) includes a multiplication and accumulation (MAC) operation circuit. In this case, the MAC operation circuit may include a plurality of multipliers, an adder tree, and an accumulator. The accumulator may include an adder and a latch circuit. In a process of performing the arithmetic operation, the first to “N”^{th} processing elements PE(0)-PE(N−1) receive weight data W from the first to “N”^{th} memory banks BK(0)-BK(N−1), respectively. In addition, the first to “N”^{th} processing elements PE(0)-PE(N−1) commonly receive vector data V from the global buffer GB. The first to “N”^{th} processing elements PE(0)-PE(N−1) perform the arithmetic operation using the weight data W and the vector data V to generate the arithmetic result data.

The memory controller 420 controls the memory access operation and the arithmetic operation on the PIM device 410. The memory controller 420 controls the memory access operation of the PIM device 410 through memory access commands, for example, a read command and a write command. In an example, the memory access operation on the PIM device 410 includes a read operation of reading data from the PIM device 410 and a write operation of writing data to the PIM device 410. The description on the access operation for the memory device 110 described with reference to FIG. 1 may be equally applied to the access operation for the PIM device 410. The memory controller 420 controls the arithmetic operation of the PIM device 410 through an arithmetic command. The arithmetic operation of the PIM device 410 may be performed by the first to “N”^{th} processing elements PE(0)-PE(N−1).

The memory controller 420 includes an address mapping table 421 in which an address mapping order is defined and a read buffer 423. The memory controller 420 controls the memory access operation of the PIM device 410, based on the address mapping order defined by the address mapping table 421. The configuration of the address mapping table 121 described with reference to FIG. 1 may be equally applied to the address mapping table 421. The read buffer 423 stores the data read from the first to “N”^{th} memory banks BK(0)-BK(N−1) of the PIM device 410. The first to “N”^{th} unique identification data UID(0)-UID(N−1) read from the first to “N”^{th} memory banks BK(0)-BK(N−1) of the PIM device 410 are stored in specific regions of the read buffer 423. The configuration of the read buffer 123 described with reference to FIG. 1 may be equally applied to the read buffer 423.

The processing unit 430 is coupled to the PIM device 410 through the memory controller 420. In an embodiment, the processing unit 430 is configured to process commands of an operating system for driving the computing system 400 or commands of an application program at the request of a user. In an embodiment, the processing unit 430 may be a central processing unit CPU. The processing unit 430 requests memory access operation or arithmetic operation to the PIM device 410. In an embodiment, the processing unit 430 transmits a request for data read from the PIM device 410 or data write to the memory device 110 to the memory controller 420. The memory controller 420 that receives the data read request from the processing unit 430 reads data from the PIM device 410, based on the address mapping order defined in the address mapping table 421. The memory controller 420 that receives a data write request from the processing unit 430 writes data to the PIM device 410, based on the address mapping order defined in the address mapping table 421. In an embodiment, the processing unit 430 transmits a request for an arithmetic operation in the PIM device 410 to the memory controller 420. The memory controller 420 that receives the arithmetic operation request from the processing unit 430 transmits an arithmetic command to the PIM device 410.

The processing unit 430 is configured to detect the address mapping order, based on the first to “N”^{th} unique identification data UID(0)-UID(N−1) stored in the first to “N”^{th} memory banks BK(0)-BK(N−1) of the PIM device 410, respectively. To this end, the processing unit 430 performs a unique identification data read request operation for unique identification data to the memory controller 420. The memory controller 420 that is requested to read the unique identification data reads the first to “N”^{th} unique identification data UID(0)-UID(N−1) from the PIM device 410 and stores the first to “N”^{th} unique identification data UID(0)-UID(N−1) in the read buffer 423 within the memory controller 420. The processing unit 430 analyzes the first to “N”^{th} unique identification data UID(0)-UID(N−1) stored in the read buffer 423 within the memory controller 420 to detect the address mapping order defined in the address mapping table 421 of the memory controller 420. Although not shown in FIG. 14, detection of the address mapping order using the first to “N”^{th} unique identification data UID(0)-UID(N−1) may also be performed during the booting process, similarly to the computing system 300 described with reference to FIG. 13.

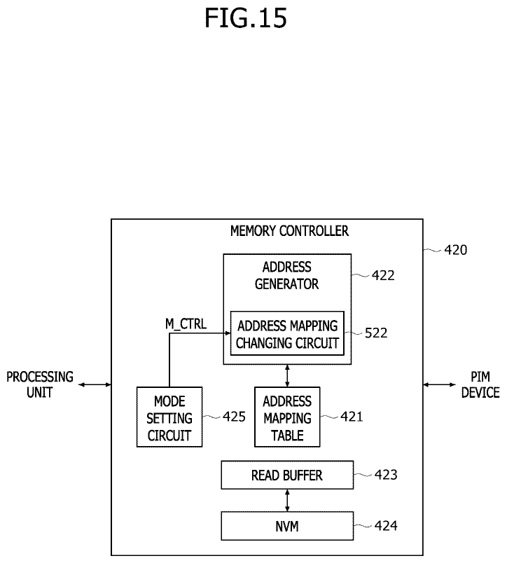

FIG. 15 is a diagram illustrating an embodiment of a memory controller 420 included in a computing system according to an embodiment of the present disclosure, for example, as shown in the computing system of FIG. 14.

Referring to FIG. 15, the memory controller 420 includes an address mapping table 421, an address generator 422, a read buffer 423, a nonvolatile memory (NVM) 424, and a mode setting circuit 425. Although not shown in FIG. 15, the memory controller 420 may include various components for controlling memory access and arithmetic operations for the PIM device, such as a command generator and a write buffer. As described with reference to FIG. 14, an address mapping order is defined in the address mapping table 421. In an example, the address mapping order represents a decoding order between banks, rows, and columns. In another example, the address mapping order represents a decoding order between channels, banks, rows, and columns. In another example, the address mapping order represents a decoding order between ranks, channels, banks, rows, and columns.

The address generator 422 generates a physical address corresponding to the address mapping order for a virtual address transmitted from the processing unit to transmit the physical address to the PIM device. The read buffer 423 has a plurality of storage regions in which read data read from the PIM device is stored. The read data stored in the read buffer 423 is transmitted to the processing unit. Some physically continuous storage regions of the plurality of storage regions of the read buffer 423 are separately allocated to store the unique identification data read from the PIM device, that is, the unique identification read data. The nonvolatile memory (NVM) 424 receives the unique identification read data stored in the read buffer 423 from the read buffer 423 and stores the unique identification read data. Accordingly, the processing unit can detect the address mapping order, based on the unique identification read data stored in the nonvolatile memory 424, regardless of whether the unique identification read data is stored in the read buffer 423. The address generator 422 includes an address mapping changing circuit 522. The address mapping changing circuit 522 may be configured to change the address mapping order defined in the address mapping table 421. For example, when the address mapping order is defined in the order of row-bank-column in the address mapping table 421, the address mapping changing circuit 522 may change the address mapping order into the order of row-column-bank.

In an embodiment, the address mapping changing circuit 522 may be enabled or disabled by a mode control signal M_CTRL transmitted from the mode setting circuit 425. The mode control signal M_CTRL may be a first mode control signal corresponding to a memory access mode, or may be a second mode control signal corresponding to an arithmetic mode. For example, the address mapping changing circuit 522 is disabled when the mode control signal M_CTRL is the first mode control signal. In this case, the address generator 422 generates an address corresponding to the first address mapping order defined in the address mapping table 421. When the mode control signal M_STRL is the second mode control signal, the address mapping changing circuit 522 is enabled. In this case, the address mapping changing circuit 522 generates an address corresponding to the second address mapping order.

The mode setting circuit 425 outputs the first mode control signal or the second mode control signal as the mode control signal by the signal transmitted from the processing unit. In an embodiment, when a request for a memory access operation of the PIM device is transmitted from the processing unit, the mode setting circuit 425 generates the first mode control signal to transmit the first mode control signal to the address mapping changing circuit 522 of the address generator 422. In this case, the address mapping changing circuit 522 is disabled. When a request for an arithmetic operation of the PIM device is transmitted from the processing unit, the mode setting circuit 425 generates the second mode control signal to transmit the second mode control signal to the address mapping changing circuit 522 of the address generator 422. In this case, the address mapping changing circuit 522 is enabled.

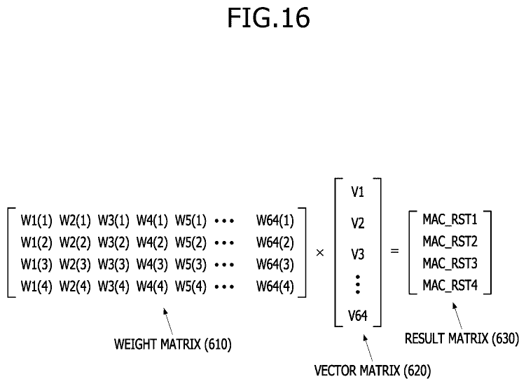

FIG. 16 is a diagram illustrating an example of a matrix multiplication operation performed in a PIM device included in a computing system according to an embodiment of the present disclosure, for example, as shown in FIG. 15.

Referring to FIG. 16 together with FIG. 15, the PIM device 410 performs a matrix multiplication operation on a weight matrix 610 and a vector matrix 620 to generate a result matrix 630. In an example below, the weight matrix 610 has four rows and sixty-four columns, and the vector matrix 620 has sixty-four rows and one column. In this case, the result matrix 630 includes four (4) rows and one column. The weight matrix 610 includes first to 64^{th} weight data W1(1)-W64(1) of a first row, first to 64^{th} weight data W1(2)-W64(2) of a second row, first to 64^{th} weight data W1(3)-W64(3) of a third row, and first to 64^{th} weight data W1(4)-W64(4) of a fourth row. The vector matrix 620 includes first to 64^{th} vector data V1-V64 of a first column. In addition, the result matrix 630 includes first to 64^{th} result data MAC_RST1-MAC_RST4 of a first column.

In an embodiment, the process of performing the matrix multiplication operation on the weight matrix 610 and the vector matrix 620 to generate the result matrix 630 is performed in the MAC operation method in the first to “N”^{th} processing elements PE(0)-PE(N−1) of the PIM device 410. That is, the matrix multiplication operation in the first to “N”^{th} processing elements PE(0)-PE(N−1) is performed multiple times by repeating the matrix multiplication operation for sub-groups of the weight matrix 610 and a sub-group of the vector matrix 620 depending on the hardware resources of the first to “N”^{th} processing elements PE(0)-PE(N−1).

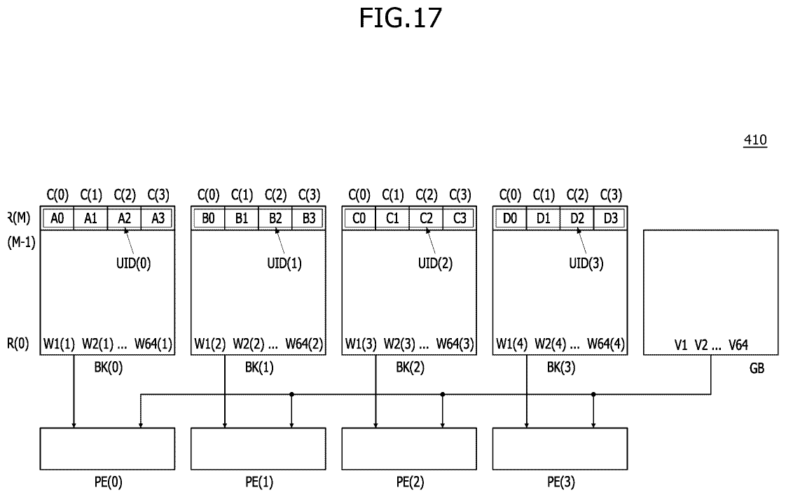

FIG. 17 is a block diagram illustrating a method of storing weight data in memory banks of a PIM device for parallel execution of a matrix multiplication operation, for example, as shown in FIG. 16. In the following examples, a PIM device 410 is exemplified as including first to fourth memory banks BK(0)-BK(3) and first to fourth processing elements PE(0)-PE(3).

Referring to FIG. 17 together with FIG. 16, the weight data W1(1)-W64(1), W1(2)-W64(2), W1(3)-W64(3), and W1(4)-W64(4) of the weight matrix 610 are stored in the first to fourth memory banks BK(0)-BK(3), respectively. In an example, the weight data W1(1)-W64(1), W1(2)-W64(2), W1(3)-W64(3), and W1(4)-W64(4) of the weight matrix 610 are stored in the same row, for example, in a first row R(0) of each of the first to fourth memory banks BK(0)-BK(3) of the PIM device 410. The vector data V1-V64 of the vector matrix 620 is stored in a global buffer GB of the PIM device 410.

As the first to fourth processing elements PE(0)-PE(3) of the PIM device 410 receive the vector data V from the global buffer GB, to perform the matrix multiplication operation of FIG. 16 in parallel, the weight data of the first to fourth rows of the weight matrix 610 of FIG. 16 is stored in the first to fourth memory banks BK(0)-BK(3), respectively. Specifically, the first to 64^{th} weight data W1(1)-W64(1) of the first row of the weight matrix 610 are stored in the first row R(0) of the first memory bank BK(0), the first to 64^{th} weight data W1(2)-W64(2) of the second row of the weight matrix 610 are stored in the first row R(0) of the second memory bank BK(1), the first to 64^{th} weight data W1(3)-W64(3) of the third row of the weight matrix 610 are stored in the first row R(0) of the third memory bank BK(2), and the first to 64^{th} weight data W1(4)-W64(4) of the fourth row of the weight matrix 610 are stored in the first row R(0) of the fourth memory bank BK(3).

For one of a plurality of MAC operations performed in the first to fourth processing elements PE(0)-PE(3) of the PIM device 410, the first processing unit PE(0) receives some of the first to 64^{th} weight data W1(1)-W64(1) of the first row of the weight matrix 610 from the first memory bank BK(0). The second processing unit PE(1) receives some of the first to 64^{th} weight data W1(2)-W64(2) of the second row of the weight matrix 610 from the second memory bank BK(1). The third processing unit PE(2) receives some of the first to 64^{th} weight data W1(3)-W64(3) of the third row of the weight matrix 610 from the third memory bank BK(2). In addition, the fourth processing unit PE(3) receives some of the first to 64^{th} weight data W1(3)-W64(3) of the fourth row of the weight matrix 610 from the fourth memory bank BK(3). The weight data transmitted to the first to fourth processing elements PE(0)-PE(3) is the weight data included in different rows of the weight matrix 610, but is the weight data included in the same columns. On the other hand, the first to fourth processing elements PE(0)-PE(3) commonly receive some of the first to 64^{th} vector data V1-V64 from the global buffer GB.

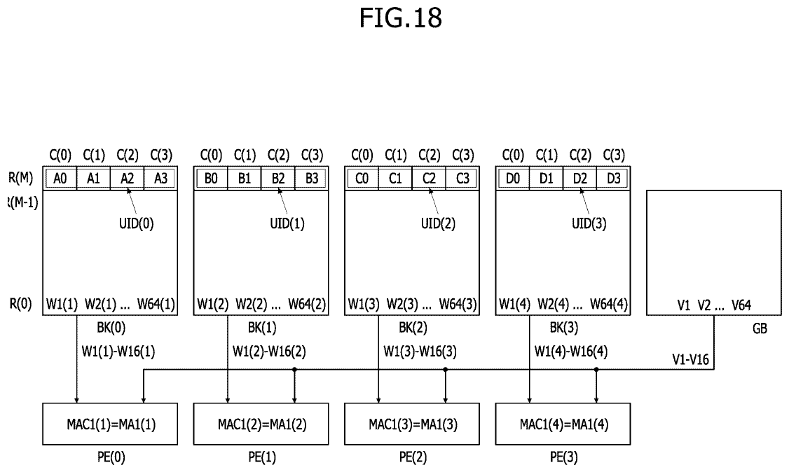

FIG. 18 illustrates a first MAC operation process in which the method of storing weight data of FIG. 17 is applied. Hereinafter, it is assumed that each of the first to fourth processing elements PE(0)-PE(3) is configured to perform the MAC operations on sixteen weight data and sixteen vector data at a time.

Referring to FIG. 18, the first processing element PE(0) receives the first to 16^{th} weight data W1(1)-W16(1) of the first row of the weight matrix 610 of FIG. 16 from the first memory bank BK(0) and receives the first to 16^{th} vector data V1-V16 of the vector matrix 620 of FIG. 16 from the global buffer GB. The first processing element PE(0) performs multiplication and addition on the first to 16^{th} weight data W1(1)-W16(1) of the first row of the weight matrix 610 and the first to 16^{th} vector data V1-V16 of the vector matrix 620 to generate first multiplication and addition data MA1(1). The first multiplication and addition data MA1(1) is latched in the first processing element PE(0) as first MAC result data MAC1(1).

The second processing element PE(1) receives the first to 16^{th} weight data W1(2)-W16(2) of the second row of the weight matrix 610 from the second memory bank BK(1) and receives the first to 16^{th} vector data V1-V16 of the vector matrix 620 from the global buffer GB. The second processing element PE(1) performs the multiplication and addition on the first to 16^{th} weight data W1(2)-W16(2) of the second row of the weight matrix 610 and the first to 16^{th} vector data V1-V16 of the vector matrix 620 to generate first multiplication and addition data MA1(2). The first multiplication and addition data MA1(2) is latched in the second processing element PE(1) as first MAC result data MAC1(2).

The third processing element PE(2) receives the first to 16^{th} weight data W1(3)-W16(3) of the third row of the weight matrix 610 from the third memory bank BK(2) and receives the first to 16^{th} vector data V1-V16 of the vector matrix 620 from the global buffer GB. The third processing element PE(2) performs the multiplication and addition on the first to 16^{th} weight data W1(3)-W16(3) of the third row of the weight matrix 610 and the first to 16^{th} vector data V1-V16 of the vector matrix 620 to generate first multiplication and addition data MA1(3). The first multiplication and addition data MA1(3) is latched in the third processing element PE(2) as first MAC result data MAC1(3).

In addition, the fourth processing element PE(3) receives the first to 16^{th} weight data W1(4)-W16(4) of the fourth row of the weight matrix 610 from the fourth memory bank BK(3) and receives the first to 16^{th} vector data V1-V16 of the vector matrix 620 from the global buffer GB. The fourth processing element PE(3) performs the multiplication and addition on the first to 16^{th} weight data W1(4)-W16(4) of the fourth row of the weight matrix 610 and the first to 16^{th} vector data V1-V16 of the vector matrix 620 to generate first multiplication and addition data MA1(4). The first multiplication and addition data MA1(4) is latched in the fourth processing element PE(3) as first MAC result data MAC1(4).

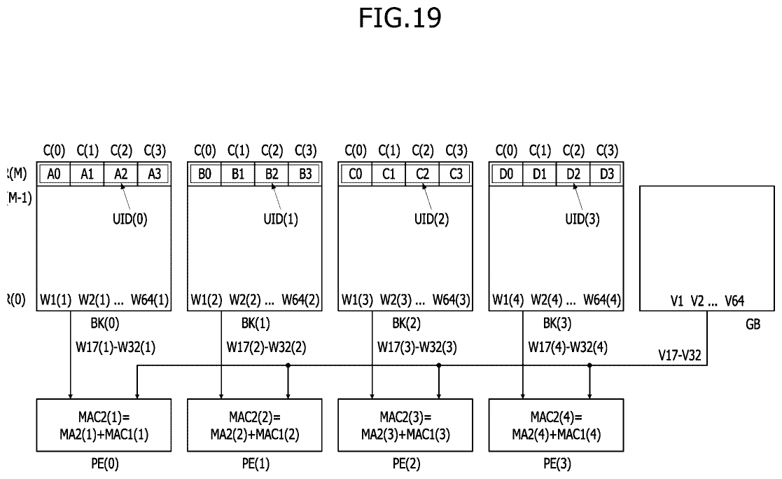

FIG. 19 illustrates a second MAC operation process in which the method of storing weight data of FIG. 17 is applied.

Referring to FIG. 19, the first processing element PE(0) receives the 17^{th} to 32^{nd} weight data W17(1)-W32(1) of the first row of the weight matrix 610 of FIG. 16 from the first memory bank BK(0) and receives the 17^{th} to 32^{nd} vector data V17-V32 of the vector matrix 620 of FIG. 16 from the global buffer GB. The first processing element PE(0) performs the multiplication and addition on the 17^{th} to 32^{nd} weight data W17(1)-W32(1) of the first row of the weight matrix 610 and the 17^{th} to 32^{nd} vector data V17-V32 of the vector matrix 620 to generate second multiplication and addition data MA2(1). The first processing element PE(0) performs accumulative addition on the second multiplication and addition data MA2(1) and the first MAC result data MAC1(1) and latches result data of the accumulative addition in the first processing element PE(0) as second MAC result data MAC2(1).

The second processing element PE(1) receives the 17^{th} to 32^{nd} weight data W17(2)-W32(2) of the second row of the weight matrix 610 from the second memory bank BK(1) and receives the 17^{th} to 32^{nd} vector data V17-V32 of the vector matrix 620 from the global buffer GB. The second processing element PE(1) performs the multiplication and addition on the 17^{th} to 32^{nd} weight data W17(2)-W32(2) of the second row of the weight matrix 610 and the 17^{th} to 32^{nd} vector data V17-V32 of the vector matrix 620 to generate second multiplication and addition data MA2(2). The second processing element PE(1) performs the accumulative addition on the second multiplication and the addition data MA2(2) and the first MAC result data MAC1(2) and latches result data of the accumulative addition in the second processing element PE(1) as second MAC result data MAC2(2).

The third processing element PE(2) receives the 17^{th} to 32^{nd} weight data W17(3)-W32(3) of the third row of the weight matrix 610 from the third memory bank BK(2) and receives the 17^{th} to 32^{nd} vector data V17-V32 of the vector matrix 620 from the global buffer GB. The third processing element PE(2) performs the multiplication and addition on the 17^{th} to 32^{nd} weight data W17(3)-W32(3) of the third row of the weight matrix 610 and the 17^{th} to 32^{nd} vector data V17-V32 of the vector matrix 620 to generate second multiplication and addition data MA2(3). The third processing element PE(2) performs the accumulative addition on the second multiplication and addition data MA2(3) and the first MAC result data MAC1(3) and latches result data of the accumulative addition in the third processing element PE(2) as second MAC result data MAC2(3).

In addition, the fourth processing element PE(3) receives the 17^{th} to 32^{nd} weight data W17(4)-W32(4) of the fourth row of the weight matrix 610 of FIG. 16 from the fourth memory bank BK(3) and receives the 17^{th} to 32^{nd} vector data V17-V32 of the vector matrix 620 of FIG. 16 from the global buffer GB. The fourth processing element PE(3) performs the multiplication and addition on the 17^{th} to 32^{nd} weight data W17(4)-W32(4) of the fourth row of the weight matrix 610 and the 17^{th} to 32^{nd} vector data V17-V32 of the vector matrix 620 to generate second multiplication and addition data MA2(4). The fourth processing element PE(3) performs the accumulative addition on the second multiplication and addition data MA2(4) and the first MAC result data MAC1(4) and latches result data of the accumulative addition in the fourth processing element PE(3) as second MAC result data MAC2(4).

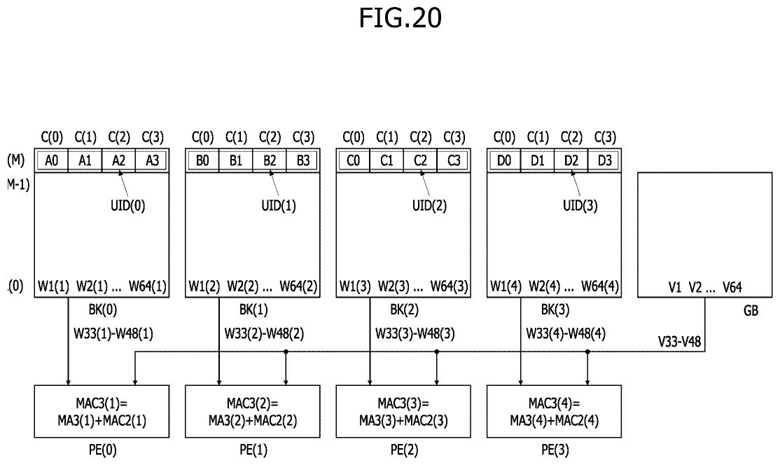

FIG. 20 illustrates a third MAC operation process in which the method of storing weight data of FIG. 17 is applied.

Referring to FIG. 20, the first processing element PE(0) receives the 33^{rd} to 48^{th} weight data W33(1)-W48(1) of the first row of the weight matrix 610 of FIG. 16 from the first memory bank BK(0) and receives the 33^{rd} to 48^{th} vector data V33-V48 of the vector matrix 620 of FIG. 16 from the global buffer GB. The first processing element PE(0) performs multiplication and addition on the 33^{rd} to 48^{th} weight data W33(1)-W48(1) of the first row of the weight matrix 610 and the 33^{rd} to 48^{th} vector data V33-V48 of the vector matrix 620 to generate third multiplication and addition data MA3(1). The first processing element PE(0) performs accumulative addition on the third multiplication and addition data MA3(1) and the second MAC result data MAC2(1) and latches result data of the accumulative addition in the first processing element PE(0) as third MAC result data MAC3(1).

The second processing element PE(1) receives the 33^{rd} to 48^{th} weight data W33(2)-W48(2) of the second row of the weight matrix 610 from the second memory bank BK(1) and receives the 33^{rd} to 48^{th} vector data V33-V48 of the vector matrix 620 from the global buffer GB. The second processing element PE(1) performs the multiplication and addition on the 33^{rd} to 48^{th} weight data W33(2)-W48(2) of the second row of the weight matrix 610 and the 33^{rd} to 48^{th} vector data V33-V48 of the vector matrix 620 to generate third multiplication and addition data MA3(2). The second processing element PE(1) performs the accumulative addition on the third multiplication and addition data MA3(2) and the second MAC result data MAC2(2) and latches result data of the accumulative addition in the second processing element PE(1) as third MAC result data MAC3(2).

The third processing element PE(2) receives the 33^{rd} to 48^{th} weight data W33(3)-W48(3) of the third row of the weight matrix 610 of FIG. 16 from the third memory bank BK(2) and receives the 33^{rd} to 48^{th} vector data V33-V48 of the vector matrix 620 of FIG. 16 from the global buffer GB. The third processing element PE(2) performs the multiplication and addition on the 33^{rd} to 48^{th} weight data W33(3)-W48(3) of the third row of the weight matrix 610 and the 33^{rd} to 48^{th} vector data V33-V48 of the vector matrix 620 to generate third multiplication and addition data MA3(3). The third processing element PE(2) performs the accumulative addition on the third multiplication and addition data MA3(3) and the second MAC result data MAC2(3) and latches result data of the accumulative addition in the third processing element PE(2) as third MAC result data MAC3(3).

In addition, the fourth processing element PE(3) receives the 33^{rd} to 48^{th} weight data W33(4)-W48(4) of the fourth row of the weight matrix 610 from the fourth memory bank BK(3) and receives the 33^{rd} to 48^{th} vector data V33-V48 of the vector matrix 620 from the global buffer GB. The fourth processing element PE(3) performs the multiplication and addition on the 33^{rd} to 48^{th} weight data W33(4)-W48(4) of the fourth row of the weight matrix 610 and the 33^{rd} to 48^{th} vector data V33-V48 of the vector matrix 620 to generate third multiplication and addition data MA3(4). The fourth processing element PE(3) performs the accumulative addition on the third multiplication and addition data MA3(4) and the second MAC result data MAC2(4) and latches result data of the accumulative addition in the fourth processing element PE(3) as third MAC result data MAC3(4).

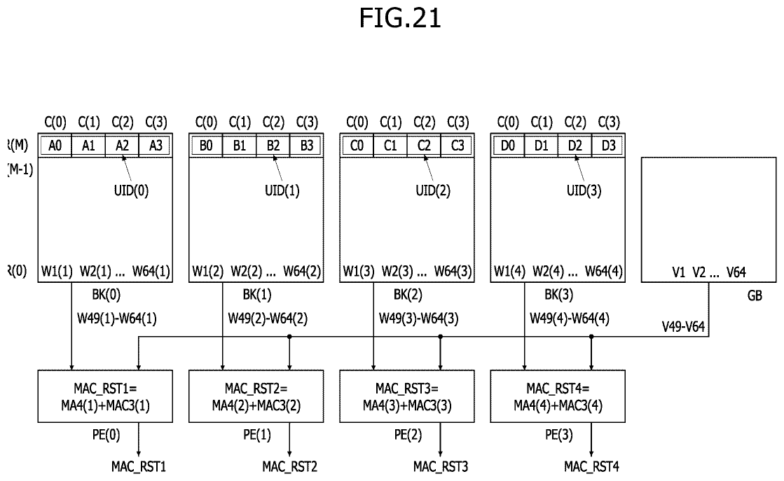

FIG. 21 illustrates a fourth MAC operation process in which the method of storing weight data of FIG. 17 is applied.

Referring to FIG. 21, the first processing element PE(0) receives the 49^{th} to 64^{th} weight data W49(1)-W64(1) of the first row of the weight matrix 610 of FIG. 16 from the first memory bank BK(0) and receives the 49^{th} to 64^{th} vector data V49-V64 of the vector matrix 620 of FIG. 16 from the global buffer GB. The first processing element PE(0) performs multiplication and addition on the 49^{th} to 64^{th} weight data W49(1)-W64(1) of the first row of the weight matrix 610 and the 49^{th} to 64^{th} vector data V49-V64 of the vector matrix 620 to generate fourth multiplication and addition data MA4(1). The first processing element PE(0) performs accumulative addition on the fourth multiplication and addition data MA4(1) and the third MAC result data MAC3(1) and outputs result data of the accumulative addition as first MAC result data MAC_RST1 of the result matrix 630 of FIG. 16.

The second processing element PE(1) receives the 49^{th} to 64^{th} weight data W49(2)-W64(2) of the second row of the weight matrix 610 from the second memory bank BK(1) and receives the 49^{th} to 64^{th} vector data V49-V64 of the vector matrix 620 from the global buffer GB. The second processing element PE(1) performs the multiplication and addition on the 49^{th} to 64^{th} weight data W49(2)-W64(2) of the second row of the weight matrix 610 and the 49^{th} to 64^{th} vector data V49-V64 of the vector matrix 620 to generate fourth multiplication and addition data MA4(2). The second processing element PE(1) performs the accumulative addition on the fourth multiplication and addition data MA4(2) and the third MAC result data MAC3(2) and outputs result data of the accumulative addition as second MAC result data MAC_RST2 of the result matrix 630.

The third processing element PE(2) receives the 49^{th} to 64^{th} weight data W49(3)-W64(3) of the third row of the weight matrix 610 from the third memory bank BK(2) and receives the 49^{th} to 64^{th} vector data V49-V64 of the vector matrix 620 from the global buffer GB. The third processing element PE(2) performs the multiplication and addition on the 49^{th} to 64^{th} weight data W49(3)-W64(3) of the third row of the weight matrix 610 and the 49^{th} to 64^{th} vector data V49-V64 of the vector matrix 620 to generate fourth multiplication and addition data MA4(3). The third processing element PE(2) performs the accumulative addition on the fourth multiplication and addition data MA4(3) and the third MAC result data MAC3(3) and outputs result data of the accumulative addition as third MAC result data MAC_RST3 of the result matrix 630.

In addition, the fourth processing element PE(3) receives the 49^{th} to 64^{th} weight data W49(4)-W64(4) of the fourth row of the weight matrix 610 from the fourth memory bank BK(3) and receives the 49^{th} to 64^{th} vector data V49-V64 of the vector matrix 620 from the global buffer GB. The fourth processing element PE(3) performs the multiplication and addition on the 49^{th} to 64^{th} weight data W49(4)-W64(4) of the fourth row of the weight matrix 610 and the 49^{th} to 64^{th} vector data V49-V64 of the vector matrix 620 to generate fourth multiplication and addition data MA4(4). The fourth processing element PE(3) performs the accumulative addition on the fourth multiplication and addition data MA4(4) and the third MAC result data MAC3(4) and outputs result data of the accumulative addition as fourth MAC result data MAC_RST4 of the result matrix 630.

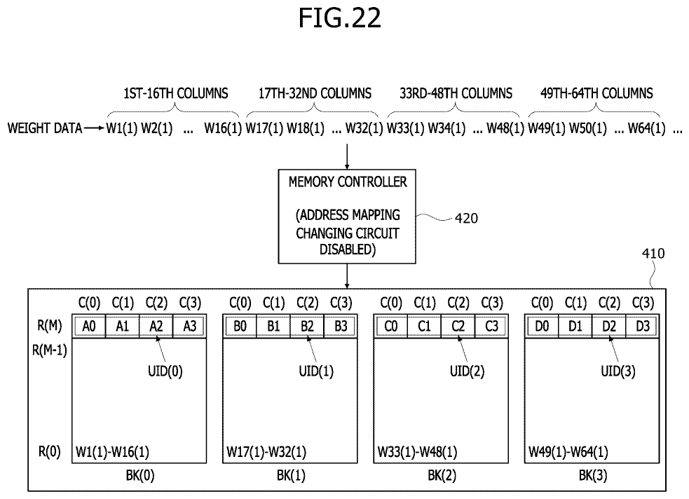

FIG. 22 illustrates an example of a process in which weight data is stored in a PIM device in a computing system according to an address mapping order defined in an address mapping table. Specifically, FIG. 22 illustrates the process in which first to 64^{th} weight data of a first row of a weight matrix are stored in a PIM device in the computing system of FIG. 14 according to a first address mapping order defined in the address mapping table. Hereinafter, it is assumed that the first address mapping order is “row-column-bank”. In addition, it is assumed that the access granularity of the PIM device is 32 bytes (that is, 256 bits) and each of the weight data includes 16 bits.

Referring to FIG. 22, the processing unit 430 transmits the first to 64^{th} weight data W1(1)-W64(1) of the first row of the weight matrix 610 of FIG. 16 to the memory controller 420 in the order in which the columns of the weight matrix 610 increase. Although not shown in FIG. 22, the processing unit 430 sequentially transmits the first to 64^{th} weight data W1(1)-W64(1) of the first row, the first to 64^{th} weight data W1(2)-W64(2) of the second row, the first to 64^{th} weight data W1(3)-W64(3) of the third row, and the first to 64^{th} weight data W1(4)-W64(4) of the fourth row to the memory controller 420.

When the address mapping changing circuit of the memory controller 420 is in a disabled state, the memory controller 420 writes the weight data W1(1)-W64(1), W1(2)-W64(2), W1(3)-W64(3), and W1(4)-W64(4) to the first to fourth memory banks BK(0)-BK(3) of the PIM device 410, respectively, according to the first address mapping order of “row-column-bank”. That is, the memory controller 420 first stores the weight data in the first to fourth memory banks BK(0)-BK(3) of the PIM device 410 in a manner in which the bank address increases, then stores the weight data in the first to fourth memory banks BK(0)-BK(3) of the PIM device 410 in a manner in which the column address increases, and finally stores the weight data in the first to fourth memory banks BK(0)-BK(3) of the PIM device 410 in a manner in which the row address increases.

Accordingly, the memory controller 420 writes 16 weight data constituting an access granularity among the first to 64^{th} weight data W1(1)-W64(1) of the first row of the weight matrix 610, that is, the first to 16^{th} weight data W1(1)-W16(1) of the first row of the weight matrix 610, to the first row R(0) and the first column region C(0) of the first memory bank BK(0) corresponding to the first row address, the first column address, and the first bank address, respectively. Next, the memory controller 420 writes the 17^{th} to 32^{nd} weight data W17(1)-W32(1) of the first row of the weight matrix 610 to the first row R(0) and the first column region C(0) of the second memory bank BK(1) corresponding to the first row address, the first column address, and the second bank address, respectively. Next, the memory controller 420 writes the 33^{rd} to 48^{th} weight data W33(1)-W48(1) of the first row of the weight matrix 610 to the first row R(0) and the first column region C(0) of the third memory bank BK(2) corresponding to the first row address, the first column address, and the third bank address, respectively. Finally, the memory controller 420 writes the 49^{th} to 64^{th} weight data W49(1)-W64(1) of the first row of the weight matrix 610 to the first row R(0) and the first column region C(0) of the fourth memory bank BK(3), corresponding to the first row address, the first column address, and the fourth bank address, respectively.

In the process of writing the first to 64^{th} weight data W1(1)-W64(1) of the first row of the weight matrix 610 to the first to fourth memory banks BK(0)-BK(3), because the bank addresses are all increased from the first bank address to the fourth bank address, the memory controller 420 writes the remaining weight data to the first to fourth memory banks BK(0)-BK(3) by increasing the bank address again while increasing the column address from the first column address to the second column address. Accordingly, although not shown in FIG. 22, the memory controller 420 writes the first to 16^{th} weight data W1(2)-W16(2) of the second row of the weight matrix 610 to the first row R(0) and the second column region C(1) of the first memory bank BK(0) corresponding to the first row address, the second column address, and the first bank address, respectively. Next, the memory controller 420 writes the 17^{th} to 32^{nd} weight data W17(2)-W32(2) of the second row of the weight matrix 610 to the first row R(0) and the second column region C(1) of the second memory bank BK(1) corresponding to the first row address, the second column address, and the second bank address, respectively. Next, the memory controller 420 writes the 33^{rd} to 48^{th} weight data W33(2)-W48(2) of the second row of the weight matrix 610 to the first row R(0) and the second column region C(1) of the third memory bank BK(2) corresponding to the first row address, the second column address, and the third bank address, respectively. Finally, the memory controller 420 writes the 49^{th} to 64^{th} weight data W49(2)-W64(2) of the second row of the weight matrix 610 to the first row R(0) and the second column region C(1) of the fourth memory bank BK(3) corresponding to the first row address, the second column address, and the fourth bank address, respectively.

Next, the memory controller 420 writes the remaining weight data to the first to fourth memory banks BK(0)-BK(3) by increasing the bank address again while increasing the column address from the second column address to the third column address. Accordingly, the memory controller 420 writes the first to 16^{th} weight data W1(3)-W16(3) of the third row of the weight matrix 610 to the first row R(0) and the third column region C(2) of the first memory bank BK(0) corresponding to the first row address, the third column address, and the first bank address, respectively. Next, the memory controller 420 writes the 17^{th} to 32^{nd} weight data W17(3)-W32(3) of the third row of the weight matrix 610 to the first row R(0) and the third column region C(2) of the second memory bank BK(1) corresponding to the first row address, the third column address, and the second bank address, respectively. Next, the memory controller 420 writes the 33^{rd} to 48^{th} weight data W33(3)-W48(3) of the third row of the weight matrix 610 to the first row R(0) and the third column region C(2) of the third memory bank BK(2) corresponding to the first row address, the third column address, and the third bank address, respectively. Finally, the memory controller 420 writes the 49^{th} to 64^{th} weight data W49(3)-W64(3) of the third row of the weight matrix 610 to the first row R(0) and the third column region C(2) of the fourth memory bank BK(3) corresponding to the first row address, the third column address, and the fourth bank address, respectively.

Next, the memory controller 420 writes the remaining weight data to the first to fourth memory banks BK(0)-BK(3) by increasing the bank address again while increasing the column address from the third column address to the fourth column address. Accordingly, the memory controller 420 writes the first to 16^{th} weight data W1(4)-W16(4) of the fourth row of the weight matrix 610 to the first row R(0) and the fourth column region C(3) of the first memory bank BK(0) corresponding to the first row address, the fourth column address, and the first bank address, respectively. Next, the memory controller 420 writes the 17^{th} to 32^{nd} weight data W17(4)-W32(4) of the fourth row of the weight matrix 610 to the first row R(0) and the fourth column region C(3) of the second memory bank BK(1) corresponding to the first row address, the fourth column address, and the second bank address, respectively. Next, the memory controller 420 writes the 33^{rd} to 48^{th} weight data W33(4)-W48(4) of the fourth row of the weight matrix 610 to the first row R(0) and the fourth column region C(3) of the third memory bank BK(2) corresponding to the first row address, the fourth column address, and the third bank address, respectively. Finally, the memory controller 420 writes the 49^{th} to 64^{th} weight data W49(4)-W64(4) of the fourth row of the weight matrix 610 to the first row R(0) and the fourth column region C(3) of the fourth memory bank BK(3) corresponding to the first row address, the fourth column address, and the fourth bank address, respectively.

According to the storing method, the first to 64^{th} weight data W1(1)-W64(1) of the first row of the weight matrix are distributed and stored in sixteen weight units in the first to fourth memory banks BK(0)-BK(3) of the PIM device 410. The first to 64^{th} weight data W1(2)-W64(2) of the second row of the weight matrix are also distributed and stored in sixteen weight units in the first to fourth memory banks BK(0)-BK(3) of the PIM device 410. The first to 64^{th} weight data W1(3)-W64(3) of the third row of the weight matrix are also distributed and stored in sixteen weight units in the first to fourth memory banks BK(0)-BK(3) of the PIM device 410. Additionally, the first to 64^{th} weight data W1(4)-W64(4) of the fourth row of the weight matrix are also distributed and stored in sixteen weight units in the first to fourth memory banks BK(0)-BK(3) of the PIM device 410. In this case, as described with reference to FIG. 17 to FIG. 21, the MAC operations in the first to fourth processing elements PE(0)-PE(3) are not performed in parallel.

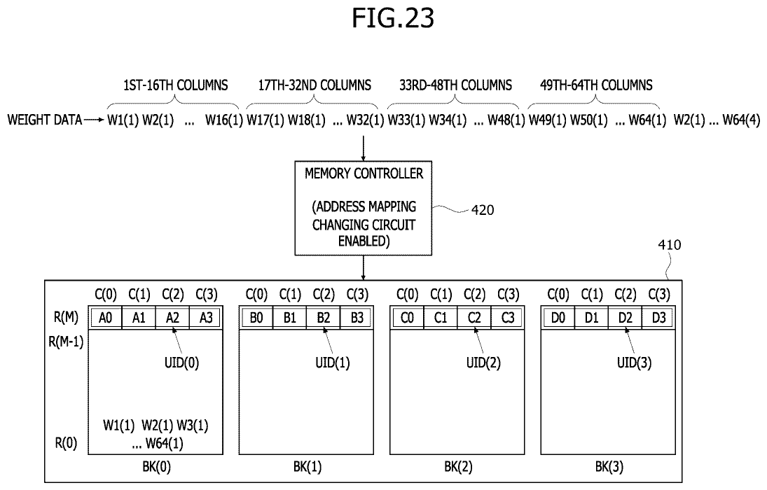

FIG. 23 to FIG. 26 illustrate a process in which first to 64^{th} weight data of a first row of a weight matrix and first to 64^{th} weight data of a fourth row of the weight matrix are stored in a PIM device according to a second address mapping order in a computing system according to an embodiment of the present disclosure, for example, as shown in FIG. 14. As described with reference to FIG. 22, in the present example, it is assumed that the processing unit 430 transmits the first to 64^{th} weight data W1(1)-W64(1) of the first row of the weight matrix 610 of FIG. 16 to the memory controller 420 in the order in which the columns of the weight matrix 610 increase.

First, referring to FIG. 23, when the address mapping changing circuit of the memory controller 420 is enabled, the memory controller 420 writes the weight data (W1(1)-W64(1), W1(2)-W64(2), W1(3)-W64(3), W1(4)-W64(4)) to the first to fourth memory banks (BK(0)-BK(3)) of the PIM device 410 according to the second address mapping order of “row-bank-column” rather than the first address mapping order of “row-column-bank”. That is, the memory controller 420 first stores the weight data in the first to fourth memory banks BK(0)-BK(3)of the PIM device 410 in a manner in which the column address increases, stores the weight data in the first to fourth memory banks BK(0)-BK(3) of the PIM device 410 in such a manner in which the bank address increases, and finally stores the eight data in the first to fourth memory banks BK(0)-BK(3) of the PIM device 410 in a manner in which the row address increases.

Accordingly, the memory controller 420 writes sixteen weight data constituting an access granularity among the first to 64^{th} weight data W1(1)-W64(1) of the first row of the weight matrix 610, that is, the first to 16^{th} weight data W1(1)-W16(1) of the first row of the weight matrix 610, to the first row R(0) and the first column region C(0) of the first memory bank BK(0) corresponding to the first row address, the first bank address, and the first column address, respectively. Next, the memory controller 420 writes the 17^{th} to 32^{nd} weight data W17(1)-W32(1) of the first row of the weight matrix 610 to the first row R(0) and the second column region C(1) of the first memory bank BK(0) corresponding to the first row address, the first bank address, and the second column address, respectively. Next, the memory controller 420 writes the 33^{rd} to 48^{th} weight data W33(1)-W48(1) of the first row of the weight matrix 610 to the first row R(0) and the third column region C(2) of the first memory bank BK(0) corresponding to the first row address, the first bank address, and the third column address, respectively. Finally, the memory controller 420 writes the 49^{th} to 64^{th} weight data W49(1)-W64(1) of the first row of the weight matrix 610 to the first row R(0) and the fourth column region C(3) of the first memory bank BK(0) corresponding to the first row address, the first bank address, and the fourth column address, respectively.

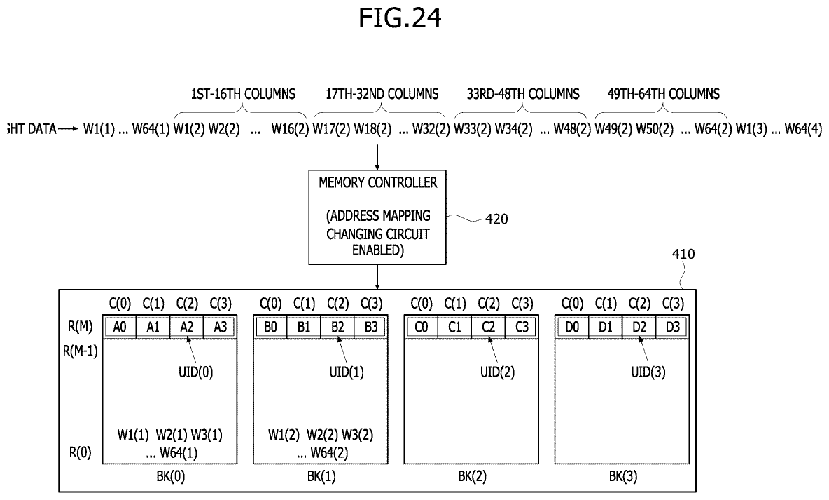

Next, referring to FIG. 24, in the process of writing the first to 64^{th} weight data W1(1)-W64(1) of the first row of the weight matrix 610 to the first memory bank BK(0), because the column addresses are all increased from the first column address to the fourth column address, the memory controller 420 performs a write operation for the remaining weight data by increasing the column address again while increasing the bank address from the first bank address to the second bank address. Specifically, the memory controller 420 writes the first to 16^{th} weight data W1(2)-W16(2) of the second row of the weight matrix 610 to the first row R(0) and the first column region C(0) of the second memory bank BK(1) corresponding to the first row address, the second bank address, and the first column address, respectively. Next, the memory controller 420 writes the 17^{th} to 32^{nd} weight data W17(2)-W32(2) of the second row of the weight matrix 610 to the first row R(0) and the second column region C(1) of the second memory bank BK(1) corresponding to the first row address, the second bank address, and the second column address, respectively. Next, the memory controller 420 writes the 33^{rd} to 48^{th} weight data W33(2)-W48(2) of the second row of the weight matrix 610 to the first row R(0) and the third column region C(2) of the second memory bank BK(1) corresponding to the first row address, the second bank address, and the third column address, respectively. Finally, the memory controller 420 writes the 49^{th} to 64^{th} weight data W49(1)-W64(1) of the second row of the weight matrix 610 to the first row R(0) and the fourth column region C(3) of the second memory bank BK(1) corresponding to the first row address, the second bank address, and the fourth column address, respectively.

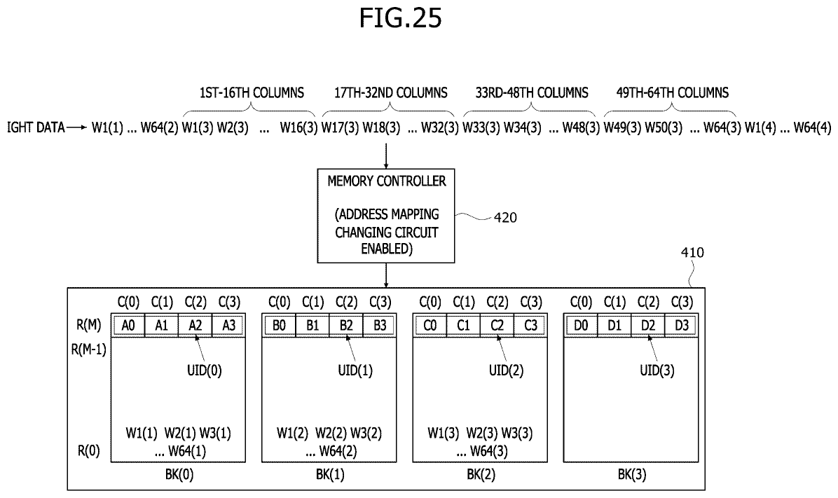

Next, referring to FIG. 25, in the process of writing the first to 64^{th} weight data W1(2)-W64(2) of the second row of the weight matrix 610 in the second memory bank BK(1), because the column addresses are all increased from the first column address to the fourth column address, the memory controller 420 performs a write operation for the remaining weight data by increasing the column address again while increasing the bank address from the second bank address to the third bank address. Specifically, the memory controller 420 writes the first to 16^{th} weight data W1(3)-W16(3) of the third row of the weight matrix 610 to the first row R(0) and the first column region C(0) of the third memory bank BK(2) corresponding to the first row address, the third bank address, and the first column address, respectively. Next, the memory controller 420 writes the 17^{th} to 32^{nd} weight data W17(3)-W32(3) of the third row of the weight matrix 610 to the first row R(0) and the second column region C(1) of the third memory bank BK(2) corresponding to the first row address, the third bank address, and the second column address, respectively. Next, the memory controller 420 writes the 33^{rd} to 48^{th} weight data W33(3)-W48(3) of the third row of the weight matrix 610 to the first row R(0) and the third column region C(2) of the third memory bank BK(2) corresponding to the first row address, the third bank address, and the third column address, respectively. Finally, the memory controller 420 writes the 49^{th} to 64^{th} weight data W49(3)-W64(3) of the third row of the weight matrix 610 to the first row R(0) and the fourth column region C(3) of the third memory bank BK(2) corresponding to the first row address, the third bank address, and the fourth column address, respectively.

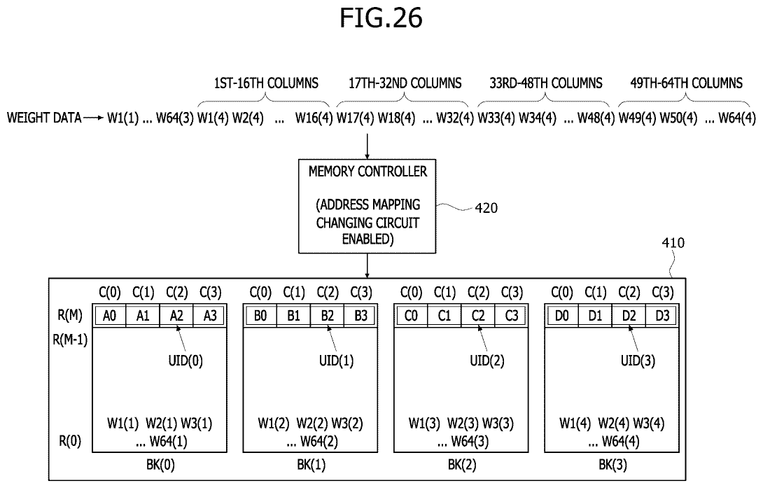

Next, referring to FIG. 26, in the process of writing the first to 64^{th} weight data W1(3)-W64(3) of the third row of the weight matrix 610 to the third memory bank BK(2), because the column addresses are all increased from the first column address to the fourth column address, the memory controller 420 performs a write operation for the remaining weight data by increasing the column address again while increasing the bank address from the third bank address to the fourth bank address. Specifically, the memory controller 420 writes the first to 16^{th} weight data W1(4)-W16(4) of the fourth row of the weight matrix 610 to the first row R(0) and the first column region C(0) of the fourth memory bank BK(3) corresponding to the first row address, the fourth bank address, and the first column address, respectively. Next, the memory controller 420 writes the 17^{th} to 32^{nd} weight data W17(4)-W32(4) of the fourth row of the weight matrix 610 to the first row R(0) and the second column region C(1) of the fourth memory bank BK(3) corresponding to the first row address, the fourth bank address, and the second column address, respectively. Next, the memory controller 420 writes the 33^{rd} to 48^{th} weight data W33(4)-W48(4) of the fourth row of the weight matrix 610 to the first row R(0) and the third column region C(2) of the fourth memory bank BK(3) corresponding to the first row address, the fourth bank address, and the third column address, respectively. Finally, the memory controller 420 writes the 49^{th} to 64^{th} weight data W49(4)-W64(4) of the fourth row of the weight matrix 610 to the first row R(0) and the fourth column region C(3) of the fourth memory bank BK(3) corresponding to the first row address, the fourth bank address, and the fourth column address, respectively.

As described with reference to FIG. 23 to FIG. 26, when the address mapping changing circuit of the memory controller 420 is enabled and the weight data of the weight matrix 610 is written to the PIM device 410, the first to 64^{th} weight data W1(1)-W64(1) of the first row of the weight matrix 610 are stored in the first memory bank BK(0), the first to 64^{th} weight data W1(2)-W64(2) of the second row are stored in the second memory bank BK(1), the first to 64^{th} weight data W1(3)-W64(3) of the third row are stored in the third memory bank BK(2), and the first to 64^{th} weight data W1(4)-W64(4) of the fourth row are stored in the fourth memory bank BK(3). Therefore, in this case, as described with reference to FIG. 17 to FIG. 21, the MAC operations in the first to fourth processing elements PE(0)-PE(3) are performed in parallel.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A computing system comprising:
a memory device including a plurality of memory banks, each of the plurality of memory banks having a plurality of unique identification data;
a memory controller configured to control an access operation on the memory device based on an address mapping order; and
a processing unit coupled to the memory device through the memory controller,
wherein the processing unit is configured to detect the address mapping order based on the plurality of unique identification data of the memory device.

2. The computing system of claim 1,
wherein each of the plurality of memory banks includes a plurality of rows and a plurality of column regions, and
wherein the plurality of rows include a first row group in which a data read operation and a data write operation are performed and a second row group in which the plurality of unique identification data is stored.

3. The computing system of claim 2, wherein each of the plurality of column regions has a size equal to an access granularity of the memory device.

4. The computing system of claim 2,
wherein the memory device includes first to “N”^{th} memory banks, each of the first to “N”^{th} memory banks having first to “F”^{th} column regions,
wherein the first to “N”^{th} memory banks includes first to “N”^{th} unique identification data, respectively,
wherein among the first to “N”^{th} unique identification data, a “K”^{th} unique identification data includes first to “T”^{th} portions stored in the rows belonging to the second row group of a “K”^{th} memory bank,
wherein “N” is a natural number of 2 or more,
wherein “F” is a natural number of 2 or more,
wherein “K” is a natural number from 1 to “N,” and
wherein “T” is (the number of rows belonging to the second row group ×“F”).

5. The computing system of claim 4, wherein each of the first to “T”^{th} portions of the “K”^{th} unique identification data includes column identification bits, row identification bits, and identification data bits.

6. The computing system of claim 5, wherein the column identification bits included in each of the first to “T”^{th} portions of the “K”^{th} unique identification data include binary values corresponding to “K”^{th} column identification data that specifies a column region.

7. The computing system of claim 6, wherein each of the column identification bits has a size of “n”-bit satisfying a condition of “2ⁿ≥F”.

8. The computing system of claim 5, wherein the row identification bits included in each of the first to “T”^{th} portions of the “K”^{th} unique identification data include binary values corresponding to “K”^{th} row identification data that specifies the rows.

9. The computing system of claim 8, wherein each of the row identification bits has a size of “m”-bit satisfying a condition of “2^{m}≥(the number of rows included in the second row group)”.

10. The computing system of claim 5, wherein the identification data bits included in each of the first to “T”^{th} portions of the “K”^{th} unique identification data include binary values corresponding to “K”^{th} bank identification data that specifies the “K”^{th} memory bank.

11. The computing system of claim 10, wherein each of the identification data bits has a bit size corresponding to “access granularity-(number of bits of column identification bits +number of bits of row identification bits)”.

12. The computing system of claim 5, wherein among the first to “T”^{th} portions of the “K”^{th} unique identification data, the portions stored in the same column region have the same binary values stored in the column identification bits.

13. The computing system of claim 5, wherein among the first to “T”^{th} portions of the “K”^{th} unique identification data, the portions stored in the same row have the same binary value stored in the row identification bits.

14. The computing system of claim 5, wherein the first to “T”^{th} portions of the “K”^{th} unique identification data have the same binary values stored in the identification data bits.

15. The computing system of claim 1,
wherein the memory controller includes:
an address mapping table configured to define the address mapping order;
an address generator configured to generate a physical address corresponding to the address mapping order and transmit the physical address to the memory device; and
a read buffer configured to read the plurality of unique identification data from the memory device and store the plurality of unique identification data as unique identification read data, and
wherein the address generator is configured to change the address mapping order defined in the address mapping table, based on the unique identification read data stored in the read buffer.

16. The computing system of claim 15, wherein the memory controller is configured to store the unique identification read data in physically continuous storage regions among storage regions of the read buffer.

17. The computing system of claim 15, wherein the memory controller further includes a nonvolatile memory that receives and stores the unique identification read data from the read buffer.

18. The computing system of claim 17, wherein the processing unit is configured to:
detect the address mapping order based on the unique identification read data when the unique identification read data exists in the read buffer or nonvolatile memory of the memory controller, and
perform a read operation on the unique identification data so that the unique identification read data is stored in the read buffer or nonvolatile memory of the memory controller when the unique identification read data does not exist in the read buffer or nonvolatile memory of the memory controller.

19. The computing system of claim 18, wherein the processing unit is configured to:
allocate physically continuous storage regions in the read buffer of the memory controller as storage regions to store the unique identification data, and
transmit a read request for the unique identification data to the memory controller.

20. The computing system of claim 19, wherein the memory controller is configured to:
read the unique identification data from the memory device in response to the read request, and
store the unique identification data transmitted from the memory device as the unique identification read data in the allocated storage regions of the read buffer.
